(19) United States
(12) Patent Application Publication
(10) Pub. No.: US 2013/0082189 A1
(43) Pub. Date: Apr. 4, 2013

(54) PRE-ALIGNED MULTI-BEAM NOZZLE/SKIMMER MODULE

(71) Applicants: Robert K. Becker, Danvers, MA (US); Avrum Freytsis, Salem, MA (US); Matthew Gwinn, Winchendon, MA (US)

(72) Inventors: Robert K. Becker, Danvers, MA (US); Avrum Freytsis, Salem, MA (US); Matthew Gwinn, Winchendon, MA (US)

(73) Assignee: TEL EPION INC., Billerica, MA (US)

(21) Appl. No.: 13/250,553

(22) Filed: Sep. 30, 2011

(51) Int. Cl. H01J 27/02; B05B 1/14

(52) U.S. Cl. 250/423 R; 239/548

(57) ABSTRACT

A pre-aligned multi-output nozzle/skimmer (PMNS) module includes a pre-aligned nozzle assembly having at least two nozzles and a pre-aligned skimmer subassembly. The PMNS module can be pre-aligned to more accurately position a Multi-Beam Gas Cluster Ion Beam (MBGCIB), and to more accurately control the formation of the multi-beam gas clusters of a pre-aligned MBGCIB.

### CROSS-REFERENCE TO RELATED APPLICATIONS

This application is related to co-pending U.S. patent application Ser. No. 12/415,883, entitled “PRE-ALIGNED NOZZLE/SKIMMER” (Ref. No. EP-139), filed on Mar. 31, 2009, the content of which is incorporated by reference herein in its entirety. This application is also related to co-pending U.S. patent application Ser. No. 12/428,973 entitled “METHOD OF IRRADIATING SUBSTRATE WITH GAS CLUSTER ION BEAM FORMED FROM MULTIPLE GAS NOZZLES” (Ref. No. EP-172), filed on Apr. 23, 2009, the content of which is incorporated by reference in its entirety.

### BACKGROUND OF THE INVENTION

1. Field of Invention

The invention relates to a nozzle/skimmer module in a gas cluster ion beam (GCIB) system and methods of using a GCIB produced therewith.

2. Description of Related Art

Gas cluster ion beams (GCIB's) are used for doping, etching, cleaning, smoothing, and growing or depositing layers on a substrate. For purposes of this discussion, gas clusters are nano-sized aggregates of materials that are gaseous under conditions of standard temperature and pressure. Such gas clusters may consist of aggregates including a few to several thousand molecules, or more, that are loosely bound together. The gas clusters can be ionized by electron bombardment, which permits the gas clusters to be formed into directed beams of controllable energy. Such cluster ions each typically carry positive charges given by the product of the magnitude of the electronic charge and an integer greater than or equal to one that represents the charge state of the cluster ion. The larger sized cluster ions are often the most useful because of their ability to carry substantial energy per cluster ion, while yet having only modest energy per individual molecule. The ion clusters disintegrate on impact with the substrate. Each individual molecule in a particular disintegrated ion cluster carries only a small fraction of the total cluster energy. Consequently, the impact effects of large ion clusters are substantial, but are limited to a very shallow surface region. This makes gas cluster ions effective for a variety of surface modification processes, but without the tendency to produce deeper sub-surface damage that is characteristic of conventional ion beam processing.

Conventional cluster ion sources produce cluster ions having a wide size distribution scaling with the number of molecules in each cluster that may reach several thousand molecules. Clusters of atoms can be formed by the condensation of individual gas atoms (or molecules) during the adiabatic expansion of high pressure gas from a nozzle into a vacuum. A gas skimmer with a small aperture strips divergent streams from the core of this expanding gas flow to produce a collimated beam of clusters. Neutral clusters of various sizes are produced and held together by weak inter-atomic forces known as Van der Waals forces. This method has been used to produce beams of clusters from a variety of gases, such as helium, neon, argon, krypton, xenon, nitrogen, oxygen, carbon dioxide, sulfur hexafluoride, nitric oxide, nitrous oxide, and mixtures of these gases. Several emerging applications for GCIB processing of substrates on an industrial scale are in the semiconductor field. Although GCIB processing of a substrate is performed using a wide variety of gas-cluster source gases, many of which are inert gases, many semiconductor processing applications use reactive source gases, sometimes in combination or mixture with inert or noble gases, to form the GCIB. Certain gas or gas mixture combinations are incompatible due to their reactivity, so a need exists for a GCIB system which overcomes the incompatibility problem.

### SUMMARY OF THE INVENTION

The present invention relates to a pre-aligned multi-beam nozzle/skimmer (PMNS) module for creating a multi-beam gas cluster ion beam (MBGCIB), a system configured for irradiating substrates using the MBGCIB, and associated methods for irradiating substrates to dope, grow, deposit, or modify layers on a substrate using the MBGCIB. The PMNS module includes two or more nozzles and an improved skimmer subassembly to more accurately control the formation of the MBGCIB. The PMNS module can be pre-aligned to more accurately position the MBGCIB.

According to an embodiment, a PMNS module is provided for use in a MBGCIB system. The PMNS module comprises a support tube having a substantially closed portion and a substantially open portion coupled to the substantially closed potion, the support tube defining a partially-open process space. A nozzle assembly structure is removably coupled to the substantially closed portion of the support tube, and a skimmer subassembly having a skimmer opening and a skimmer output is removably coupled to the substantially open portion of the support tube. A dual nozzle assembly is coupled to the nozzle assembly structure with a first nozzle configured to emit a first pre-aligned internal beam of gas clusters towards the skimmer opening and a second nozzle configured to emit a second pre-aligned internal beam of gas clusters towards the skimmer opening. The skimmer subassembly is configured to then create an external multi-beam gas cluster beam (MBGCB) from the first and second pre-aligned internal beams, and emit the MBGCB from the skimmer output.

According to a further embodiment, a MBGCIB system is provided comprising the PMNS module, an ionizer, and a substrate holder. According to another embodiment, a MBGCIB processing system is provided that comprises a source subsystem that includes a PMNS module, an ionization/acceleration subsystem, and a processing subsystem. The source subsystem can include a source chamber having an interior space in which the PMNS module is configured, the ionization/acceleration subsystem can include an ionization/acceleration chamber, and the processing subsystem can include a processing chamber. The PMNS module includes a first nozzle and a second nozzle and is configured to provide a pre-aligned MBGCB into the ionization/acceleration chamber.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 illustrates a simplified block diagram of an exemplary pre-aligned multi-beam nozzle/skimmer (PMNS) module in accordance with embodiments of the invention;

FIG. 2 shows an exemplary configuration for a multi-beam gas cluster ion beam (MBGCIB) system in accordance with embodiments of the invention;

FIG. 3 illustrates a partial block diagram of an exemplary PMNS in accordance with embodiments of the invention;

FIG. 4 illustrates a partial block diagram of another exemplary PMNS in accordance with embodiments of the invention;

FIG. 5 illustrates a partial block diagram of an additional exemplary PMNS in accordance with embodiments of the invention;

FIGS. 6A-6H illustrate a variety of nozzle configurations in accordance with embodiments of the invention; and

FIG. 7 illustrates a flow chart of a method for irradiating a substrate using a PMNS module in a MBGCIB system in accordance with embodiments of the invention.

### DETAILED DESCRIPTION

In the following description, in order to facilitate a thorough understanding of the invention and for purposes of explanation and not limitation, specific details are set forth, such as a particular geometry of the metrology system and descriptions of various components and processes. However, it should be understood that the invention may be practiced in other embodiments that depart from these specific details.

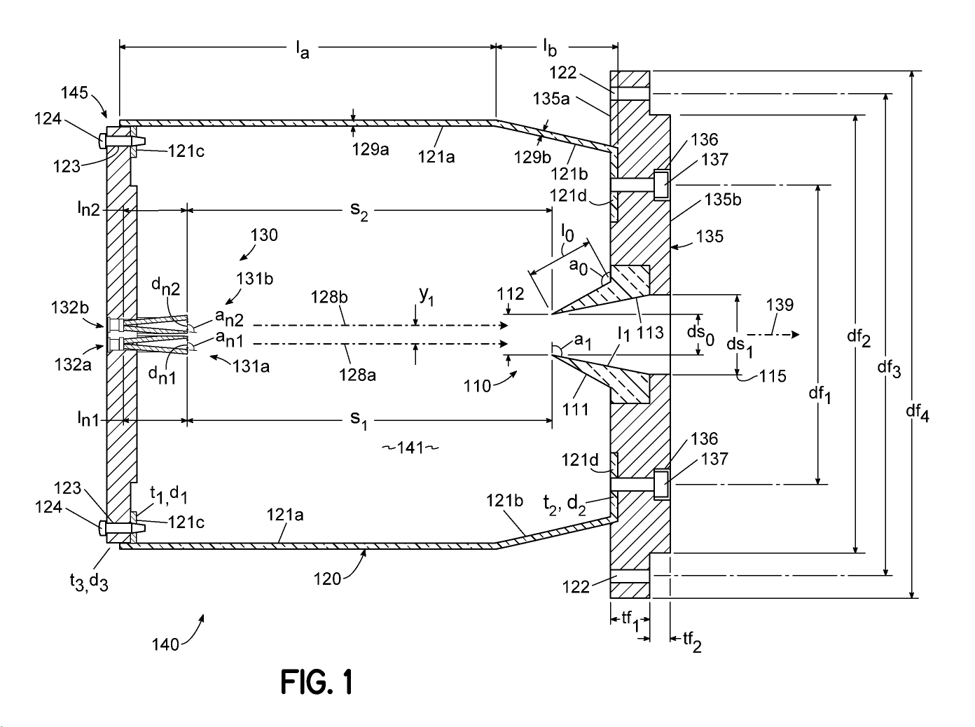

FIG. 1 illustrates a simplified block diagram of an exemplary pre-aligned multi-beam nozzle/skimmer (PMNS) module in accordance with embodiments of the invention. In the illustrated embodiment, an exemplary PMNS module 140 is shown that can operate as a pre-aligned multi-beam gas cluster ion beam (MBGCIB) source.

Designing a PMNS module can reduce the alignment issues. The current design involves a fixed skimmer and adjustable nozzle, which can require readjustment after a vent cycle. Subtle changes can occur in beam shape/profile when the nozzle manipulator is adjusted in the current design. By pre-aligning the two or more nozzles and the internal skimmer element in the PMNS module 140, adjustment issues can be reduced or possibly eliminated. By constructing the two or more nozzles and the internal skimmer in fixed predetermined configuration, the beam alignment in a MBGCIB system can be simplified significantly, and the PMNS module 140 can decrease the maintenance time and increase overall beam stability. The PMNS module can be aligned using a dedicated test stand that could use Schlieren optics to maximize efficient gas transport through a single skimmer assembly or a dual skimmer assembly for the multi-beam gas cluster beam (MBGCB).

When the PMNS module 140 is pre-aligned; it can be pre-aligned for a first gas composition and a second gas composition. For example, the first gas composition can include a condensable inert gas that can include a noble gas, i.e., He, Ne, Ar, Kr, Xe, or Rn, and the second gas compositions can comprise a film forming gas composition, an etching gas composition, a cleaning gas composition, a smoothing gas composition, etc. In addition, the PMNS module 140 can be configured to produce ionizable clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof.

The PMNS module 140 can be configured and pre-aligned to operate in a low-pressure environment and the operational pressures can range from about 0.01 mTorr to about 100 mTorr.

The PMNS module 140 can be constructed using a dual nozzle assembly 130 having a first nozzle 131a for establishing a first internal beam 128a, a second nozzle 131b for establishing a second internal beam 128b, a skimmer subassembly 110 for establishing at least one external multi-beam gas cluster beam (MBGCB) 139 and a support tube 120. In some embodiments, the external MBGCB 139 can include two or more substantially parallel cluster beams. In other embodiments, the external MBGCB 139 can include two or more substantially coalesced cluster beams.

In some designs, the dual nozzle assembly 130 can be removably coupled to a nozzle assembly structure 145. In other designs, the dual nozzle assembly 130 can be rigidly coupled to the nozzle assembly structure 145. For example, the dual nozzle assembly 130 can be coupled to the nozzle assembly structure 145 using one or more screws or bolts (not shown). Alternatively, other attachment means may be used.

The first nozzle 131a can have a first nozzle length (lₙ₁), a first nozzle opening angle (aₙ₁), and a first nozzle diameter (dₙ₁). The first nozzle length (lₙ₁) can vary from about 20 mm to about 40 mm; the first nozzle opening angle (aₙ₁) can vary from about 90.5 degrees to about 105 degrees; and the first nozzle diameter (dₙ₁) can vary from about 2 mm to about 4 mm.

The second nozzle 131b can have a second nozzle length (lₙ₂), a second nozzle opening angle (aₙ₂), and a second nozzle diameter (dₙ₂). The second nozzle length (lₙ₂) can vary from about 20 mm to about 40 mm; the second nozzle opening angle (aₙ₂) can vary from about 90.5 degrees to about 105 degrees; and the second nozzle diameter (dₙ₂) can vary from about 2 mm to about 4 mm. In addition, a first separation distance (y₁) can be established between the first nozzle 131a and the second nozzle 131b (measured from respective center lines), and the first separation distance (y₁) can vary from about 5 mm to about 25 mm.

The support tube 120 can include a first portion 121a and a second portion 121b. The first portion 121a of the support tube 120 can be a substantially closed cylindrical subassembly having a first thickness 129a that can vary from about 0.5 mm to 5 mm. The support tube 120 can include a first mounting structure 121c coupled to the first portion 121a and the first mounting structure 121c can have a first thickness (t₁) and first inside diameter (d₁). For example, first thickness (t₁) can vary from about 0.5 mm to 5 mm, and first inside diameter (d₁) can vary from about 35 mm to 45 mm. The first mounting structure 121c of the support tube 120 can be removably coupled to the nozzle assembly structure 145 using three or more mounting holes 123 and three or more fastening devices 124 (two of each are shown). Alternatively, other attachment means may be used.

The second portion 121b of the support tube 120 can be a substantially open frustoconical assembly having a second thickness 129b that can vary from about 0.5 mm to about 5 mm. The support tube 120 can include a second mounting structure 121d coupled to the second portion 121b and the second mounting structure 121d can have a second thickness (t₂) and second inside diameter (d₂). For example, second thickness (t₂) can vary from about 0.5 mm to 5 mm, and second inside diameter (d₂) can vary from about 35 mm to 45 mm. The second mounting structure 121d of the support tube 120 can be removably coupled to a base flange assembly 135 using three or more mounting holes 136 (two shown) and three or more fastening devices 137 (two shown). Alternatively, other attachment means may be used.

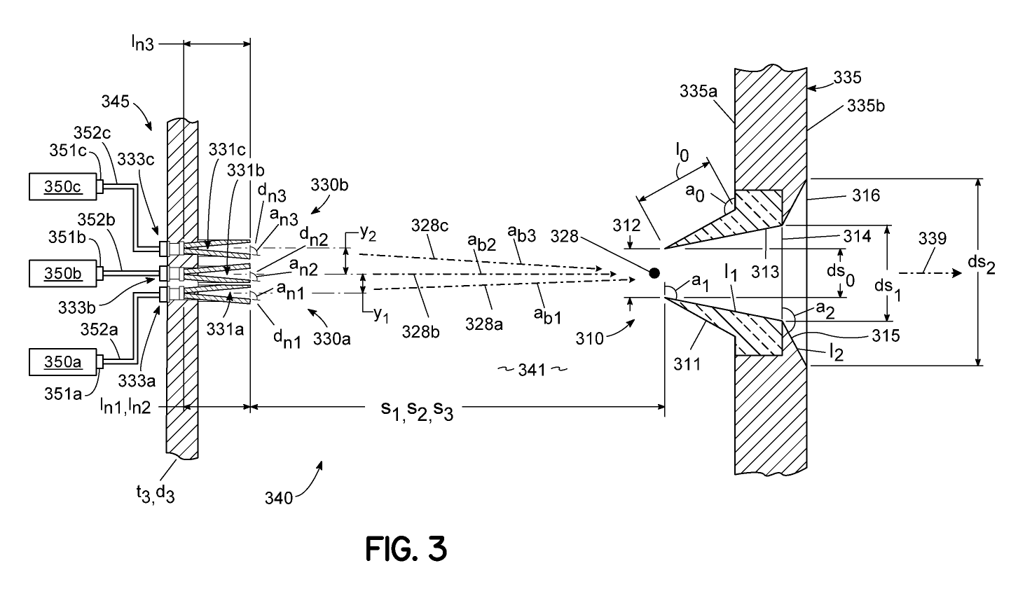

In some examples, the support tube 120 can enclose a partially-open process space 141, and a controlled low-pressure (vacuum) state can be established in the partially-open process space 141 when the PMNS module 140 is being aligned, tested and/or used. A nozzle/skimmer assembly having a support tube with a closed first portion and a substantially open second portion that form a partially-open process space can be seen in FIG. 3 of related application Ser. No. 12/415,883, referenced above.

The first portion 121a can have a first length (lₐ) that can vary from about 30 mm to about 70 mm, and the second portion 121b can have a second length (l_{b}) that can vary from about 30 mm to about 50 mm.

The skimmer subassembly 110 can be coupled to the base flange assembly 135 using three or more mounting holes (not shown) and three or more fastening devices (not shown). Alternatively, other attachment means may be used. In some examples, the skimmer subassembly 110 can have a conical configuration. Alternatively, a conical configuration may not be required. In some other designs, one or more additional skimmer assemblies may be required.

The skimmer subassembly 110 can have a skimmer opening 112 having diameter (ds₀), and the diameter (ds₀) can vary from about 0.5 mm to about 5.0 mm. The skimmer subassembly 110 can have a skimmer output 115 having diameter (ds₁), and the diameter (ds₁) can vary from about 1 mm to about 10.0 mm. The skimmer subassembly 110 can have an inner element 111 coupled to an inner wall 135a, and a length (l₀) and an angle (a₀) can also be associated with the inner element 111. The length (l₀) of the inner element 111 measured from the inner wall 135a to the skimmer opening 112 can vary from about 20 mm to about 40 mm, and the angle (a₀) from the inner wall 135a can vary from about 100 degrees to about 175 degrees. Alternatively, the inner element 111 may be configured differently.

The skimmer subassembly 110 can comprise an output shaping element 113 that can have a conical configuration. Alternatively, a conical configuration may not be required. The outer shaping element 113 can extend from the skimmer opening 112 outwardly to the skimmer output 115 adjacent to or inside of an external wall 135b of the base flange assembly 135. A first length (l₁) and a first angle (a₁) can be associated with the outer shaping element 113, and the first length (l₁) can vary from about 20 mm to about 40 mm, and the first angle (a₁) can vary from about 95 degrees to about 175 degrees. Alternatively, the outer shaping element 113 may be configured differently.

For example, the diameter (ds₀), the diameter (ds₁), the length (l₀), the angle (a₀), the first length (l₁), and the first angle (a₁) can be dependent upon the desired width for the MBGCB 139, the number of internal beams, the gas cluster sizes, and the process chemistry (gases) that the PMNS module 140 is designed to create.

The nozzle assembly structure 145, the support tube 120, the skimmer subassembly 110, the dual nozzle assembly 130, or the base flange assembly 135, or any combination or any portion thereof can be fabricated using stainless steel material. Alternatively, the nozzle assembly structure 145, the support tube 120, the skimmer subassembly 110, the dual nozzle assembly 130, or the base flange assembly 135, or any portion or any combination thereof can be fabricated using hardened and/or coated material.

The nozzle lengths (lₙ₁ and lₙ₂), the nozzle angles (aₙ₁ and aₙ₂), and the nozzle diameters (dₙ₁ and dₙ₂) can be determined by the process chemistry, the molecule size, the flow rate, the chamber pressure, the beam size, etc. for the production process recipe.

The output of the first nozzle 131a can be separated from the skimmer opening 112 by a first separation distance (s₁) that can vary from about 10 mm to about 50 mm. The output of the second nozzle 131b can be separated from the skimmer opening 112 by a second separation distance (s₂) that can vary from about 10 mm to about 50 mm. Alternatively, other separation distances (s₁) and (s₂) may be used. In use, a first internal beam 128a (gas jet) is created from the first nozzle 131a of the dual nozzle assembly 130 and is aligned with and directed towards the skimmer opening 112 in the skimmer subassembly 110. In addition, a second internal beam 128b (gas jet) is created from the second nozzle 131b of the dual nozzle assembly 130 and is aligned with and directed towards the skimmer opening 112 in the skimmer subassembly 110.

In addition, the base flange assembly 135 can comprise one or more additional mounting holes 122 that can be configured to removably couple the PMNS module 140 to a chamber wall. The multi-gas cluster beam 139 of the PMNS module 140 can be aligned in the x-direction, the y-direction, and the z-direction before PMNS module 140 is mounted to the chamber wall. Alternatively, one or more mechanical positioning devices (not shown) may be used.

The base flange assembly 135 can have a first thickness (tf₁) that can vary from about 20 mm to about 40 mm, and a second thickness (tf₂) that can vary from about 10 mm to about 20 mm. The base flange assembly 135 can have a first diameter (df₁) that can vary from about 30 mm to about 50 mm, a second diameter (df₂) that can vary from about 50 mm to about 60 mm, a third diameter (df₃) that can vary from about 70 mm to about 80 mm, and a fourth diameter (df₄) that can vary from about 80 mm to about 90 mm.

In some embodiments, the dual nozzle assembly 130 can be rigidly coupled to the nozzle assembly structure 145. In other embodiments, the dual nozzle assembly 130 may be removably coupled to the nozzle assembly. For example, when O-rings are required, they may be obtained from Vitron, Inc. The nozzle assembly structure 145 can have a third thickness (t₃) that can vary from about 2 mm to about 5 mm and a third diameter (d₃) that can vary from about 75 mm to about 95 mm. Alternatively, the nozzle assembly structure 145 may be configured differently.

In some embodiments, one or more first mixing spaces (not labeled) can be configured in the dual nozzle assembly 130 and can be coupled to the first nozzle 131a. For example, the first mixing spaces may have first lengths (not shown) that can vary from about 5 mm to about 15 mm and first diameters (not shown) that can vary from about 2 mm to about 25 mm. Alternatively, the first mixing spaces may be configured differently. When used, the first mixing spaces may be used to provide and control first process gases to the first nozzle 131a. In addition, one or more second mixing spaces (not labeled) can be configured in the dual nozzle assembly 130 and can be coupled to the second nozzle 131b. For example, second mixing spaces (not shown) may have second lengths (not shown) that can vary from about 5 mm to about 15 mm and second diameters (not shown) that may vary from about 2 mm to about 25 mm. Alternatively, the second mixing spaces may be configured differently. When used, the second mixing spaces may be used to provide and control second process gases to the second nozzle 131b.

In some embodiments, the dual nozzle assembly 130 can be pre-tested when the nozzle assembly structure 145 is initially coupled to the support tube 120, and one or more pre-tested dual nozzle subassemblies 130 can be conveniently stored on-site.

In some alignment tests, an optical input signal from an optical test source can be provided through the nozzle input elements (132a or 132b), and an optical output signal can be measured at the output of the nozzle (131a or 131b) or the skimmer opening 112 using an optical receiver. In this manner, the alignment of the internal beams (128a or 128b) can be optically tested and verified.

The nozzle input elements (132a or 132b) can include flow control devices, filters, and valves as required and can be used to control the flow rate of the processing gases into the nozzle (131a or 131b). For example, the flow rates can vary from about 10 sccm to about 5000 sccm.

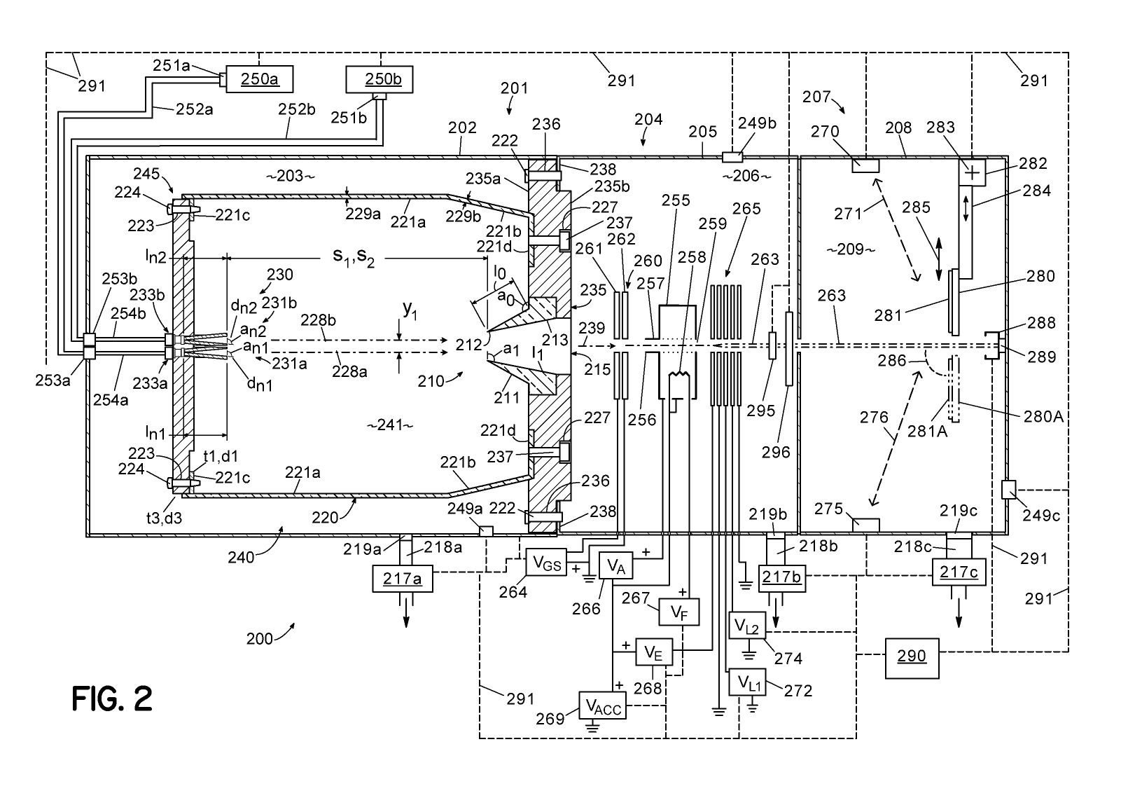

FIG. 2 shows an exemplary configuration for a MBGCIB system in accordance with embodiments of the invention. In some embodiments, the illustrated MBGCIB system 200 can be used for aligning and/or testing a pre-aligned multi-output nozzle/skimmer (PMNS) module 240 before it is mounted in a production MBGCIB processing system. In other embodiments, the illustrated MBGCIB system 200 can be used as a production MBGCIB processing system in which a PMNS module 240 is mounted that has been pre-aligned and/or tested. The MBGCIB system 200 comprises a source subsystem 201, an ionization/acceleration subsystem 204, and a processing subsystem 207. The source subsystem 201 can include a source chamber 202 having an interior space 203, the ionization/acceleration subsystem 204 can include an ionization/acceleration chamber 205 having an interior space 206, and the processing subsystem 207 can include a processing chamber 208 having an interior space 209.

The MBGCIB system 200 can include a first vacuum pumping system 217a, a second vacuum pumping system 217b, and a third vacuum pumping system 217c. One or more first pressure control elements 219a can be coupled into the source chamber 202, and one or more of the first pressure control elements 219a can be coupled to the first vacuum pumping system 217a using one or more external vacuum hoses 218a. Also, one or more second pressure control elements 217b can be coupled into the ionization/acceleration chamber 205, and one or more of the second pressure control elements 219b can be coupled to the second vacuum pumping system 217b using one or more external vacuum hoses 218b. In addition, one or more third pressure control elements 219c can be coupled into the processing chamber 208, and one or more of the third pressure control elements 219c can be coupled to the third vacuum pumping system 217c using one or more external vacuum hoses 218c.

The source chamber 202, the ionization/acceleration chamber 205, and the processing chamber 208 can be evacuated to suitable testing and/or operating pressures by the first, second and third vacuum pumping systems 217a, 217b, and 217c, respectively, when the PMNS module 240 is being aligned and/or tested, or when the “pre-aligned” PMNS module 240 is being used. In addition, the vacuum pumping system 217a can be used to establish the correct pressure in the process space 241 in the PMNS module 240 during operation. Vacuum pumping systems 217a, 217b, and 217c can include turbo-molecular vacuum pumps (TMP) capable of pumping speeds up to about 5000 liters per second (and greater) and a gate valve for throttling the chamber pressure. In conventional vacuum processing devices, a 1000 to 2000 liter per second TMP can be employed. TMPs are useful for low pressure processing, typically less than about 50 mTorr.

Furthermore, in some embodiments, a first chamber pressure monitoring device 249a can be coupled to or configured within the source chamber 202, a second chamber pressure monitoring device 249b can be coupled to or configured within the ionization/acceleration chamber 205, and a third chamber pressure monitoring device 249c can be coupled to or configured within the processing chamber 208. Alternatively, a chamber pressure monitoring device may be coupled to the PMNS module 240. For example, the pressure-monitoring device can be a capacitance manometer or ionization gauge. Controller 290 can be coupled to the vacuum pumping systems (217a, 217b, and 217c) and to the chamber pressure monitoring devices (249a, 249b, and 249c) through signal bus 291. In addition, the controller 290 can monitor and/or control the vacuum pumping systems (217a, 217b, and 217c) and the chamber pressure monitoring devices (249a, 249b, and 249c) when the PMNS module 240 is being aligned and/or tested, or when a correctly operating “pre-aligned” PMNS module 240 is being used.

The PMNS module 240 can be configured as described above with reference to FIG. 1. For example, the PMNS module 240 can be positioned in the source subsystem 201 of a test system (e.g., MBGCIB system 200) after the PMNS module 240 is constructed. After the PMNS module 240 is pre-aligned and/or tested, it can then be positioned in the source subsystem 201 of a multi-gas production processing system (e.g., MBGCIB system 200). The base flange assembly 235, having an inner wall 235a and an external wall 235b, can be used to removably couple the PMNS module 240 to an interior wall 238 of the source chamber 202 using the plurality of mounting holes 236 and a plurality of fastening devices 222, as shown in FIG. 2. Alternatively, the base flange assembly 235 may be used to removably couple the PMNS module 240 to an exterior wall of the source chamber 202 (not shown). The base flange assembly 235 can be aligned in the x-direction, the y-direction, and the z-direction before it is mounted within the interior space 203 of the source chamber 202. Alternatively, one or more positioning devices (not shown) may be used when mounting the PMNS module 240.

As explained above with reference to FIG. 1, support tube 220 can include a first portion 221a of first thickness 229a and a second portion 221b of second thickness 229b. The output of the first nozzle 231a of dual nozzle assembly 230 can be separated from the skimmer opening 212 of skimmer subassembly 210 by a first separation distance (s₁), which can vary, for example, from about 10 mm to about 50 mm. In addition, the output of the second nozzle 231b can be separated from the skimmer opening 212 by a second separation distance (s₂), which can vary, for example, from about 10 mm to about 50 mm. The correct separation distances (s₁) and (s₂) can be established when the PMNS module 240 is tested and/or aligned. When one or more of the separation distances (s₁) or (s₂) are not correct, the dual nozzle assembly 230, the base flange assembly 235, the support tube 220, and/or the skimmer subassembly 210 can be repositioned or re-manufactured. The separation distances (s₁) and (s₂) can be dependent upon the process chemistry (gases) that the PMNS module 240 is designed to use in a multi-gas production process system.

The first nozzle 231a can have a first nozzle length (lₙ₁), a first nozzle opening angle (aₙ₁), and a first nozzle diameter (dₙ₁). The first nozzle length (lₙ₁) can vary from about 20 mm to about 40 mm; the first nozzle opening angle (aₙ₁) can vary from about 90.5 degrees to about 105 degrees; and the first nozzle diameter (dₙ₁) can vary from about 2 mm to about 4 mm.

The second nozzle 231b can have a second nozzle length (lₙ₂), a second nozzle opening angle (aₙ₂), and a second nozzle diameter (dₙ₂). The second nozzle length (lₙ₂) can vary from about 20 mm to about 40 mm; the second nozzle opening angle (aₙ₂) can vary from about 90.5 degrees to about 105 degrees; and the second nozzle diameter (dₙ₂) can vary from about 2 mm to about 4 mm. In addition, a first separation distance (y₁) can be established between the first nozzle 231a and the second nozzle 231b (measured from respective center lines), and the first separation distance (y₁) can vary from about 5 mm to about 25 mm.

When the PMNS module 240 is aligned and/or tested, the skimmer subassembly 210 can be aligned with the first nozzle 231a such that the first internal beam 228a established from the first nozzle 231a is aligned with and directed towards the skimmer opening 212 in the skimmer subassembly 210. In some embodiments, the first nozzle 231a can be pre-tested and/or pre-aligned before it is coupled into the dual nozzle assembly 230. Further, one or more pre-tested and/or pre-aligned first nozzles 231a can be configured differently, and the differences can be determined by the process chemistry, the molecule size, the flow rate, the chamber pressure, the cluster size, the beam size, etc. In addition, one or more pre-tested and/or pre-aligned first nozzles 231a can be stored on-site to facilitate the use of other process recipes.

When the PMNS module 240 is aligned and/or tested, the skimmer subassembly 210 can also be aligned with the second nozzle 231b such that the second internal beam 228b established from the second nozzle 231b is aligned with and directed towards the skimmer opening 212 in the skimmer subassembly 210. In some embodiments, the second nozzles 231b can be pre-tested and/or pre-aligned before it is coupled into the dual nozzle assembly 230. Further, one or more pre-tested and/or pre-aligned second nozzle 231b can be configured differently, and the differences can be determined by the process chemistry, the molecule size, the flow rate, the chamber pressure, the cluster size, the beam size, etc. In addition, one or more pre-tested and/or pre-aligned second nozzles 231b can be stored on-site to facilitate the use of other process recipes.

When the internal beams (228a and 228b) are aligned correctly, the third portion 221c of the support tube 220 can be rigidly and removably coupled to the nozzle assembly structure 245 using two or more first mounting holes 223 and two or more first fastening devices 224, and the fourth portion 221d of the support tube 220 can be rigidly and removably coupled to the base flange assembly 235 using the second mounting holes 227 and second fastening devices 237 to maintain the correct alignment.

In some embodiments, as discussed above, the nozzles (231a and 231b) can be pre-tested when the dual nozzle assembly 230 is initially coupled to the support tube 220, and one or more pre-tested dual nozzle assemblies 230 can be conveniently stored on-site. For example, during alignment and/or testing of the nozzles (231a and 231b), one or more controlled test gas sources can provide one or more test gases at one or more different flow rates to the nozzles (231a and 231b) through first gas transition elements 233a and/or second gas transition element 233b.

As discussed above, the PMNS module 240 can include first gas transition elements 233a that can be configured to provide first process gas to the first nozzle 231a at a first controlled flow rate and second gas transition elements 233b that can be configured to provide second process gas to the second nozzle 231b at a second controlled flow rate.

A first gas feed tube assembly 254a can be coupled to the first gas transition elements 233a, and a second gas feed tube assembly 254b can be coupled to the second gas transition elements 233b. A first gas input supply assembly 253a can be coupled to the first gas feed tube assembly 254a, and a second gas input supply assembly 253b can be coupled to the second gas feed tube assembly 254b. For example, the gas input supply assemblies 253a, 253b can be used to removably couple the PMNS module 240 to the gas supply systems (250a and 250b, discussed below). In addition, the gas feed tube assemblies 254a, 254b can be attached to the wall of the source chamber 202.

In various embodiments, the gas input supply assemblies 253a, 253b and/or the gas feed tube assemblies 254a, 254b can include flow control devices, filters, and valves as required. The gas input supply assemblies (253a, 253b) can be used to control the flow rate of the processing gases into the PMNS module 240. For example, the flow rates can vary from about 10 sccm to about 3000 sccm.

When the PMNS module 240 is aligned and/or tested, the PMNS module 240 can produce a test multi-beam gas cluster beam (MBGCB) 239 that can be directed into the interior space 206 in the ionization/acceleration chamber 205. The “pre-aligned” PMNS module 240 can then be configured in a production MBGCIB system 200 that can provide improved multi-gas GCIB processes for a workpiece 281, which may be a semiconductor wafer, a thin film on a substrate, or other workpiece that requires improved GCIB processing. When the “pre-aligned” PMNS module 240 is used in the MBGCIB system 200, the “pre-aligned” PMNS module 240 can produce a pre-aligned MBGCB 239 that can be directed into the interior space 206 in the ionization/acceleration chamber 205 to process the workpiece 281.

Some MBGCIB systems 200 can include a first gas supply subsystem 250a, and a second gas supply subsystem 250b. The first gas supply subsystem 250a can be coupled to one or more first gas control units 251a for controlling a first gas composition. The first gas control units 251a can be coupled to the first gas feed tube assembly 254a using one or more of the first external gas supply lines 252a. The second gas supply subsystem 250b can be coupled to one or more second gas control units 251b for controlling a second gas composition. The second gas control units 251b can be coupled to the second gas feed tube assembly 254b using one or more of the external gas supply lines 252b. A first gas composition stored in the first gas supply subsystem 250a and/or a second gas composition stored in the second gas supply subsystem 250b can be used when the PMNS module 240 is being aligned and/or tested or when it is being used in a multi-gas production process

In some examples, the PMNS module 240 can be configured to use a first gas composition, and the first gas composition can include a condensable inert gas that can include a noble gas, i.e., He, Ne, Ar, Kr, Xe, or Rn. In addition, the PMNS module 240 can be configured to use a second gas composition that can comprise a film forming gas composition, an etching gas composition, a cleaning gas composition, a smoothing gas composition, etc. Furthermore, the first gas supply subsystem 250a and the second process gas supply subsystem 250b may be utilized either alone or in combination with one another when the PMNS module 240 is configured to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof.

During alignment, testing, and/or MBGCIB processing, the first gas composition and/or the second gas composition may be provided to the PMNS module 240 at a high pressure to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof. For example, the first gas composition can be introduced into a first mixing space in the first nozzle 231a and can be ejected into the substantially lower pressure vacuum in the partially-open process space 241 inside the support tube 220 through the first nozzle 231a. When the first high-pressure condensable gas from the first nozzle 231a expands into the lower pressure region of the partially-open process space 241, the gas molecule velocities can approach supersonic speeds and a first internal beam 228a (gas jet) is created between the first nozzle 231a and the skimmer opening 212. In addition, the second gas composition can be introduced into a second mixing space in the second nozzle 231b and can be ejected into the substantially lower pressure vacuum in the partially-open process space 241 inside the support tube 220 through the second nozzle 231b. When the second high-pressure condensable gas from the second nozzle 231b expands into the lower pressure region of the partially-open process space 241, the gas molecule velocities can approach supersonic speeds and a second internal beam 228b (gas jet) is created between the second nozzle 231b and the skimmer opening 212. Then, an external MBGCB 239 of multi-gas clusters can emanate from the skimmer output 215 in the PMNS module 240.

The external gas supply lines (252a and 252b) can be both gas tight and non-reactive with the variety of gases used. For example, a double walled woven stainless steel mesh with a Kapton or Gore-Tex inner membrane to allow for flex without high gas permeation can be used.

The source chamber 202 can be a closed structure that is configured to sustain a low pressure therein. One or more of the walls of the source chamber 202 can include a non-reactive metal, such as stainless steel or coated aluminum.

As discussed above, the source subsystem 201 can include one or more first pressure control elements 219a coupled into the source chamber 202, and coupled to the first vacuum pumping system 217a using one or more external vacuum hoses 218a. In alternate embodiments, one or more internal vacuum hoses (not shown) may be coupled to the support tube 220 and may be used to control the pressure in the interior process space 241 of the support tube 220.

Supersonic gas jets are generated as internal beams (228a, 228b) in the PMNS module 240. Cooling, which results from the expansion in these jets, causes a portion of the supersonic gas jets to condense into clusters, each consisting of from several to several thousand weakly bound atoms or molecules. The skimmer subassembly 210 in the PMNS module 240 partially separates the gas molecules that have not condensed into a cluster jet from the cluster jet so as to minimize pressure in the downstream regions where such higher pressures would be detrimental (e.g., ionizer 255, high voltage electrodes 265, and processing chamber 208). Suitable condensable processing gases can include, but are not necessarily limited to argon, nitrogen, carbon dioxide, oxygen, and other gases. The inner element 211 and the outer shaping element 213 are preferably conical and form an external MBGCB 239 that is substantially cylindrical.

During some alignment and/or testing procedures or processing procedures, the external MBGCB 239 from the PMNS module 240 can contain multi-gas clusters, and the external MBGCB 239 of multi-gas clusters can be sent through an electron suppressor apparatus 260. Alternatively, an electron suppressor apparatus 260 may not be required or may be used at a different location during some alignment, testing, and/or multi-gas processing procedures. The electron suppressor apparatus 260 can comprise an electrically conductive electron suppressor electrode 261 at a first potential, a secondary electrode 262 at a second potential, and a suppressor electrode bias power supply 264. Suppressor electrode bias power supply 264 provides a glitch suppression voltage V_{GS} and the V_{GS} test range can vary from about 1 kV to about 5 kV. The electron suppressor electrode 261 can be negatively biased with respect to secondary electrode 262 and the PMNS module 240, and the secondary electrode 262 and PMNS module 240 can be at about the same potential during testing and/or processing. Electron suppressor electrode 261 and secondary electrode 262 each have a coaxially-aligned aperture for transmission of the MBGCB 239 (neutral supersonic gas jet). The negatively biased electron suppressor apparatus 260 provides an electric field in the region between the skimmer output 215 and the electron suppressor electrode 261 that causes any secondary electrons ejected from the PMNS module 240 output region to follow trajectories that return them toward the output of PMNS module 240 or electrically connected adjacent regions and prevents them from being accelerated and producing ionization in the external MBGCB 239 (supersonic gas jet) in the region between PMNS module 240 and the ionizer 255. Both an extension tube 257 and electron suppressor apparatus 260 contribute to reduction of beam glitches due to discharges and arcing in the region between the output of the PMNS module 240 and the ionizer 255. Used in combination as shown in FIG. 2, they are significantly more effective than the sum of their independent contributions. The combination reduces to a negligible level the skimmer-ionizer discharge as a source of beam glitching and has enabled production of stable GCIB beam currents on the order of 500 to 1000 microamperes with glitch rates from all causes on the order of one per hour. This is an improvement of from 10 times to 100 times over previously obtained results from conventional systems. Alternatively, magnetic electron suppressors and other electron gates may be used.

During some alignment, testing, and/or processing procedures, the supersonic gas clusters in the MBGCB 239 that exit from the electron suppressor apparatus 260 can be ionized in an ionizer 255, which preferably has a substantially cylindrical geometry coaxially aligned with the supersonic clusters in the external MBGCB 239. The ionizer 255 can be an electron impact ionizer that produces thermoelectrons from one or more ionizer filaments 258 and accelerates and directs the electrons causing them to collide with the supersonic gas clusters in the MBGCB 239, as the jet (beam) passes through the ionizer 255. The electron impact ejects electrons from the clusters, causing a portion the clusters to become positively ionized. A set of suitably biased high voltage electrodes 265 extracts the cluster ions from the ionizer, forming a beam, then accelerates them to a desired energy (typically from 1 keV to several tens of keV) and focuses them to form a MBGCIB 263.

During various exemplary tests and processes, a filament power supply 267 can provide filament voltage V_{F} to heat the ionizer filament 258. An anode power supply 266 can provide anode voltage V_{A} to accelerate thermoelectrons emitted from the ionizer filament 258 to cause them to irradiate the cluster-containing external MBGCB 239 to produce multi-gas ions. A test extraction power supply 268 can provide extraction voltage V_{E} to bias a high voltage electrode to extract ions from the ionizing region of ionizer 255 and to form a MBGCIB 263. An accelerator power supply 269 can provide acceleration voltage V_{ACC} to bias a high voltage electrode with respect to the ionizer 255 so as to result in a total GCIB acceleration equal to V_{ACC}. One or more lens power supplies (272 and 274) can be provided to bias high voltage electrodes with focusing voltages (V_{L1} and V_{L2}) to create a MBGCIB 263 that can be shaped and/or focused.

The MBGCIB system 200 can include an X-scan controller 282 that provides linear motion of a workpiece holder 280 in the direction of X-scan motion 283 (into and out of the plane of the paper). A Y-scan controller 284 provides linear motion of the workpiece holder 280 in the direction of Y-scan motion 285, which is typically orthogonal to the X-scan motion 283. During some alignment, testing, and/or processing procedures, the combination of X-scanning and Y-scanning motions can move a workpiece 281, held by the workpiece holder 280, in a raster-like scanning motion through the MBGCIB 263. When the MBGCIB system 200 is operating correctly, the MBGCIB 263 can provide a uniform irradiation of a surface of the workpiece 281 thereby causing a uniform processing of the workpiece 281. A controller 290, which may be a microcomputer based controller connects to the X-scan controller 282 and the Y-scan controller 284 through signal bus 291 and controls the X-scan controller 282 and the Y-scan controller 284 so as to place the workpiece 281 into or out of the MBGCIB 263 and to scan the workpiece 281 uniformly relative to the MBGCIB 263 to achieve uniform processing of the workpiece 281 by the MBGCIB 263.

During some test and/or processing procedures, the workpiece holder 280 can position the workpiece 281 at an angle with respect to the axis of the MBGCIB 263 so that the MGCIB 263 has a beam incidence angle 286 with respect to the surface of the workpiece 281. When the MGCIB system 200 is operating correctly, the beam incidence angle 286 may be about 90 degrees. During Y-scan testing, the workpiece 281 can be held by workpiece holder 280 and can be moved from the position shown to the alternate position “A” indicated by the designators 281A and 280A respectively. When a scanning procedure is performed correctly, the workpiece 281 can be completely scanned through the MGCIB 263, and in the two extreme positions, the workpiece 281 can be moved completely out of the path of the MGCIB 263 (over-scanned). In addition, similar scanning and/or over-scanning can be performed in the orthogonal X-scan motion 283 direction (in and out of the plane of the paper). During some test cases, the PMNS module 240 can be adjusted and/or re-aligned when the test scanning procedure fails.

The workpiece 281 can be affixed to the workpiece holder 280 using a clamping system (not shown), such as a mechanical clamping system or an electrical clamping system (e.g., an electrostatic clamping system). Furthermore, workpiece holder 280 may include a heating system (not shown) or a cooling system (not shown) that is configured to adjust and/or control the temperature of workpiece holder 280 and workpiece 281.

A beam current sensor 288 can be positioned beyond the workpiece holder 280 in the path of the MGCIB 263 and can be used to intercept a sample of the MGCIB 263 when the workpiece holder 280 is scanned out of the path of the MGCIB 263. The beam current sensor 288 can be a Faraday cup or the like, and can be closed except for a beam-entry opening, and can be attached to a wall of the processing chamber 208 using an electrically insulating mount 289. Alternatively, one or more sensing devices may be coupled to the workpiece holder 280.

The MGCIB 263 can impact the workpiece 281 at a projected impact region on a surface of the workpiece 281. During X-Y testing and processing, the workpiece holder 280 can position each portion of a surface of the workpiece 281 in the path of MGCIB 263 so that every region of the surface of the workpiece 281 can be processed by the MGCIB 263. The X-scan and Y-scan controllers 282, 284 can be used to control the position and velocity of workpiece holder 280 in the X-axis and the Y-axis directions. The X-scan and Y-scan controllers 282, 284 can receive control signals from controller 290 through signal bus 291. During various tests and processes, the workpiece holder 280 can be moved in a continuous motion or in a stepwise motion to position different regions of the workpiece 281 within the MGCIB 263. In one embodiment, the workpiece holder 280 can be controlled by the controller 390 to scan, with programmable velocity, any portion of the workpiece 281 through the MGCIB 263.

In some exemplary test or processing sequences, one or more of the surface of the workpiece holder 280 can be constructed to be electrically conductive and can be connected to a dosimetry processor operated by controller 290. An electrically insulating layer (not shown) of workpiece holder 280 may be used to isolate the workpiece 281 and substrate holding surface from the other portions of the workpiece holder 280. Electrical charge induced in the workpiece 281 by impinging the MGCIB 263 may be conducted through the workpiece 281 and the workpiece holder 280 surface, and a signal can be coupled through the workpiece holder 280 to controller 290 for dosimetry measurement. Dosimetry measurement has integrating means for integrating the MGCIB current to determine a MGCIB processing dose. Under certain circumstances, a target-neutralizing source (not shown) of electrons, sometimes referred to as electron flood, may be used to neutralize the MGCIB 263. In such case, a Faraday cup may be used to assure accurate dosimetry despite the added source of electrical charge. During processing of the workpiece 281, the dose rate can be communicated to the controller 290, and the controller 290 can confirm that the MGCIB flux is correct or to detect variations in the MGCIB flux.

Controller 290 can also receive the sampled beam current collected by the beam current sensor 288 via signal bus 291. The controller 290 can monitor the position of the MGCIB 263, can control the MGCIB dose received by the workpiece 281, and can remove the workpiece 281 from the MGCIB 263 when a predetermined desired dose has been delivered to the workpiece 281. Alternatively, an internal controller may be used.

The MGCIB system 200 as shown in FIG. 2 includes mechanisms permitting increased MGCIB currents while reducing or minimizing “glitches.” A tubular conductor, such as extension tube 257, is shown as an integral part of the ionizer 255 disposed at the entrance aperture 256 of the ionizer 255; however, the extension tube 257 need not be so integrally connected. The extension tube 257 is electrically conductive and electrically attached to the ionizer 255 and is thus at the ionizer potential. Other configurations, which achieve about the same potential relationship between the extension tube 257 and the ionizer 255, may be employed. The ionizer entrance aperture 256 diameter can vary from about 2 cm to about 4 cm. Extension tube 257 has an inner diameter that can vary from about 2 cm to about 4 cm. The length of the extension tube 257 can vary from about 2 cm to about 8 cm. The walls of extension tube 257 are electrically conductive, preferably metallic, and may be perforated or configured as a plurality of connected, coaxial rings or made of screen material to improve gas conductance. Extension tube 257 shields the interior of the ionizer 255 from external electric fields, reducing the likelihood that a positive ion formed near the entrance aperture 256 of the ionizer 255 will be extracted backwards out of the ionizer 255 and accelerated toward the output end of the PMNS module 240. The ionizer exit aperture 259 diameter can vary from about 2 cm to about 4 cm.

The MGCIB system 200 may further include an in-situ metrology system. For example, the in-situ metrology system may include an optical diagnostic system having an optical transmitter 270 and optical receiver 275 configured to illuminate the workpiece 281 with an incident optical signal 271 and to receive a scattered optical signal 276 from the workpiece 281, respectively. The optical diagnostic system comprises optical windows to permit the passage of the incident optical signal 271 and the scattered optical signal 276 into and out of the processing chamber 208. Furthermore, the optical transmitter 270 and the optical receiver 275 may comprise transmitting and receiving optics, respectively. The optical transmitter 270 can be coupled to and communicate with the controller 290. The optical receiver 275 returns measurement signals to the controller 290. For example, the in-situ metrology system may be configured to monitor the progress of the MGCIB processing.

Controller 290 comprises one or more microprocessors, memory, and I/O ports capable of generating control voltages sufficient to communicate and activate inputs to the MGCIB system 200 as well as monitor outputs from the MGCIB system 200. Moreover, controller 290 can be coupled to and can exchange information with vacuum pumping systems 217a, 217b, and 217c, first gas supply subsystem 250a, second gas supply subsystem 250b, PMNS module 240, gas transition elements 233a and 233b, suppressor electrode bias power supply 264, anode power supply 266, filament power supply 267, extraction power supply 268, accelerator power supply 269, lens power supplies 272 and 274, the optical transmitter 270, the optical receiver 275, X-scan and Y-scan controllers 282 and 284, and beam current sensor 288. For example, a program stored in the memory can be utilized to activate the inputs to the aforementioned components of the MGCIB system 200 according to a process recipe in order to perform a test or production MGCIB process on a workpiece 281.

In some test embodiments, a beam filter 295 can be positioned in the ionization/acceleration chamber 205 and can be used to eliminate monomers or monomers and light ionized clusters from the MGCIB 263 to further define the MGCIB 263 before it enters the processing chamber 208. In addition, a beam gate 296 can be disposed in the path of MGCIB 263 in the ionization/acceleration chamber 205. For example, the beam gate 296 can have an open state in which the MGCIB 263 is permitted to pass from the ionization/acceleration chamber 205 to the processing subsystem 207 and a closed state in which the MGCIB 263 is blocked from entering the processing subsystem 207. The controller 290 can be coupled to the beam filter 295 and the beam gate 296, and the controller 290 can monitor and control the beam filter 295 and the beam gate 296 during testing or processing.

Alternatively, an adjustable aperture may be incorporated with the beam filter 295 or included as a separate device (not shown), to throttle or variably block a portion of a GCIB flux thereby reducing the GCIB beam current to a desired value. The adjustable aperture may be employed alone or with other devices and methods known to one skilled in the art to reduce the GCIB flux to a very small value, including varying the gas flow from a GCIB source supply; modulating the ionizer by either varying a filament voltage V_{F} or varying an anode voltage V_{A}; or modulating the lens focus by varying lens voltages V_{L1} and/or V_{L2}.

During some procedures, when an ionized gas cluster ion impinge on a surface of a workpiece 281, a shallow impact crater can be formed with a width of about 20 nm and a depth of about 10 nm, but less than about 25 nm. When imaged using a nano-scale imaging device such as Atomic Force Microscopy (AFM), the impact craters have an appearance similar to indentations. After impact, the inert species from the gas cluster ion vaporizes, or escapes the surface of the workpiece 281 as a gas and is exhausted from the processing subsystem 207 and processing chamber 208 by the vacuum pumping system 217c.

FIG. 3 illustrates a partial block diagram of an exemplary PMNS having three nozzles in accordance with embodiments of the invention. The illustrated partial PMNS module 340 comprises nozzle assembly structure 345 to which is removably coupled a dual nozzle assembly 330a with first and second nozzles 331a and 331b, and a single nozzle assembly 330b with third nozzle 331c. PMNS module 340 further comprises a first skimmer subassembly 310 having an inner element 311, a first outer shaping element 313, and a second outer shaping element 315. The first outer shaping element 313 can extend from a skimmer opening 312 outwardly to a first circular opening 314 of diameter ds₁ adjacent to or inside of an external wall 335b of the base flange assembly 335. The second outer shaping element 315 can extend from the first circular opening 314 outwardly to a second circular opening 316 of diameter ds₂ that intersects with the external wall 335b.

Inner element 311 can be coupled to an inner wall 335a, and can have a length (l₀) and an angle (a₀). The length (l₀) of the inner element 311 measured from the inner wall 335a to the skimmer opening 312 can vary from about 20 mm to about 40 mm, and the angle (a₀) from the inner wall 335a can vary from about 100 degrees to about 175 degrees. Skimmer opening 312 can have a diameter ds₀, which can vary from about 0.5 mm to about 5.0 mm. The diameter (ds₀), the length (l₀) and the angle (a₀) can be dependent upon the desired width for the MBGCB 339, the gas cluster size, and the process chemistry (gases) that the PMNS module 340 is designed to create. Alternatively, the inner element 311 may be configured differently.

A first length (l₁) and a first angle (a₁) can be associated with the first outer shaping element 313, and a second length (l₂) and a second angle (a₂) can be associated with the second outer shaping element 315. The first length (l₁) can vary from about 20 mm to about 40 mm, and the first angle (a₁) can vary from about 95 degrees to about 175 degrees. The second length (l₂) can vary from about 10 mm to about 30 mm, and the second angle (a₂) can vary from about 100 degrees to about 175 degrees. The first length (l₁), the first angle (a₁), the second length (l₂), and the second angle (a₂) can be dependent upon the desired width for internal beams 328a-328c, the MCGB 339, the gas cluster size, and the process chemistry (gases) that the PMNS module 340 is designed to create. Alternatively, the outer shaping elements 313 and 315 may be configured differently or may not be required.

In other embodiments, the skimmer subassemblies 110 (FIG. 1) or 210 (FIG. 2) may be used to replace the skimmer subassembly 310.

The output of the first nozzle 331a can be separated from the skimmer opening 312 by a first separation distance (s₁) that can vary from about 10 mm to about 50 mm. The output of the second nozzle 331b can be separated from the skimmer opening 312 by a second separation distance (s₂) that can vary from about 10 mm to about 50 mm. In addition, the output of the third nozzle 331c can be separated from the skimmer opening 312 by a third separation distance (s₃) that can vary from about 10 mm to about 50 mm. Alternatively, other separation distances (s₁), (s₂), and (s₃) may be used. In use, a first internal beam 328a (gas jet) is created at a first beam angle (a_{b1}) from the first nozzle 331a of the dual nozzle assembly 330a and is aligned with and directed towards a beam summation point 328 proximate to the skimmer opening 312 in the skimmer subassembly 310. A second internal beam 328b (gas jet) is created at a second beam angle (a_{b2}) from the second nozzle 331b of the dual nozzle assembly 330a and is aligned with and directed towards the beam summation point 328 proximate to the skimmer opening 312 in the skimmer subassembly 310. In addition, a third internal beam 328c (gas jet) is created at a third beam angle (a_{b3}) from the third nozzle 331c of the single nozzle assembly 330b and is aligned with and directed towards the beam summation point 328 proximate to the skimmer opening 312 in the skimmer subassembly 310. For example, the beam angles (a_{b1}, a_{b2}, and a_{b3}) can vary from about −15 degrees to about +15 degrees from a horizontal reference. Alternatively, the nozzles 331a, 331b, and 331c may be configured differently.

The first and second nozzles 331a, 331b of dual nozzle assembly 330a can have first and second nozzle lengths (lₙ₁ and lₙ₂), first and second nozzle opening angles (aₐ₁ and aₙ₂), and first and second nozzle diameters (dₙ₁ and dₙ₂). The first and second nozzle lengths (lₙ₁ and lₙ₂) can each vary from about 20 mm to about 40 mm; the first and second nozzle opening angles (aₙ₁ and aₙ₂) can each vary from about 90.5 degrees to about 105 degrees; and the first and second nozzle diameters (dₙ₁ and dₙ₂) can each vary from about 2 mm to about 4 mm.

The third nozzle 331c of single nozzle assembly 330b can have a third nozzle length (lₙ₃), a third nozzle opening angle (aₙ₃), and a third nozzle diameter (dₙ₃). The third nozzle length (lₙ₃) can vary from about 20 mm to about 40 mm; the third nozzle opening angle (aₙ₃) can vary from about 90.5 degrees to about 105 degrees; and the third nozzle diameter (dₙ₃) can vary from about 2 mm to about 4 mm.

In addition, a first separation distance (y₁) can be established between the first nozzle 331a and the second nozzle 331b (measured from the center lines), and the first separation distance (y₁) can vary from about 5 mm to about 25 mm. Furthermore, a second separation distance (y₂) can be established between the third nozzle 331c and the second nozzle 331b (measured from the center lines), and the second separation distance (y₂) can vary from about 5 mm to about 25 mm.

The MBGCB 339 of the PMNS module 340 can be aligned in the x-direction, the y-direction, and the z-direction before PMNS module 340 is mounted to the chamber wall. Alternatively, one or more mechanical positioning devices (not shown) may be used.

When the PMNS module 340 is aligned and/or tested, the skimmer subassembly 310 can be aligned with the first and second nozzles 331a and 331b in the dual nozzle assembly 330a and with the additional third nozzle 331c in the single nozzle assembly 330b. A first internal beam 328a can be established using the first nozzle 331a, a second internal beam 328b can be established using the second nozzle 331b, and a third internal beam 328c can be established using the third nozzle 331c. The internal beams 328a, 328b, and 328c can be aligned with and directed towards the skimmer opening 312 in the skimmer subassembly 310.

In some embodiments, the first and second nozzles 331a and 331b in the dual nozzle assembly 330a and additional third nozzle 331c in the single nozzle assembly 330b can be pre-tested and/or pre-aligned before being used. The nozzles 331a, 331b, and 331c can be configured differently, and the differences can be determined by the process chemistry, the molecule size, the flow rate, the chamber pressure, the cluster size, the beam size, etc. In addition, one or more pre-tested and/or pre-aligned dual and/or single nozzle assemblies 330a and/or 330b can be stored on-site to facilitate the use of other process recipes.

In some embodiments, the first nozzle 331a can be coupled to a first gas transition element 333a, the second nozzle 331b can be coupled to a second gas transition element 333b, and the third nozzle 331c can be coupled to a third gas transition element 333c. The first gas transition element 333a can be configured to provide a first process gas to the first nozzle 331a at a first controlled flow rate, the second gas transition element 333b can be configured to provide a second process gas to the second nozzle 331b at a second controlled flow rate, and the third gas transition element 333c can be configured to provide a third process gas to the third nozzle 331c at a third controlled flow rate.

A first gas feed tube 352a can be coupled to the first gas transition element 333a, a second gas feed tube 352b can be coupled to the second gas transition element 333b, and a third gas feed tube 352c can be coupled to the third gas transition element 333c.

A first gas control unit 351a can be coupled to the first gas feed tube 352a and to a first gas supply system 350a, a second gas control unit 351b can be coupled to the second gas feed tube 352b and to a second gas supply system 350b, and a third gas control unit 351c can be coupled to the third gas feed tube 352c and to a third gas supply system 350c. For example, the gas transition elements 333a, 333b, and 333c can be used to removably couple the PMNS module 340 to the gas supply systems 350a, 350b, and 350c.

In some alignment tests, an optical input signal from an optical test source can be provided through one of the gas transition elements 333a, 333b, and 333c, and an optical output signal can be measured at the output of the respective nozzle 331a, 331b, or 331c, or at the skimmer opening 312, or at the beam summation point 328 using an optical receiver. In this manner, the alignment of the internal beam 328a, 328b, or 328c and the position of the beam summation point 328 can be optically tested and verified. Alternatively, the beam summation point 328 may not be required.

The gas transition elements 333a, 333b, and 333c can include flow control devices, filters, and valves as required and can be used to control the flow rate of the processing gases into the nozzles 331a, 331b, and 331c. For example, the flow rates can vary from about 10 sccm to about 5000 sccm. The gas control units 351a, 351b, and 351c can control the gas compositions from the gas supply subsystems 350a, 350b, and 350c. For example, a first gas composition stored in the first gas supply subsystem 350a, a second gas composition stored in the second gas supply subsystem 350b, and/or a third gas composition stored in the third gas supply subsystem 350c can be used when the PMNS module 340 is being aligned and/or tested or when it is being used in a MBGCIB production process.

In some examples, one or more of the gas supply subsystems 350a, 350b, and 350c can be configured to use a condensable inert gas that can include a noble gas, i.e., He, Ne, Ar, Kr, Xe, or Rn. In addition, one or more of the gas supply subsystems 350a, 350b, and 350c can be configured to use a film forming gas composition, an etching gas composition, a cleaning gas composition, a smoothing gas composition, etc. Furthermore, the gas supply subsystems 350a, 350b, and 350c may be utilized either alone or in combination with one another when the PMNS module 340 is configured to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof.

During alignment, testing, and/or MBGCIB processing, the gas supply subsystems 350a, 350b, and 350c can provide one or more gas compositions to the PMNS module 340 at a high pressure to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof. For example, the first gas composition can be introduced into the first gas transition element 333a and can be ejected into the substantially lower pressure vacuum in the partially-open process space 341 through the first nozzle 331a. When the first high-pressure condensable gas from the first nozzle 331a expands into the lower pressure region of the partially-open process space 341, the gas molecule velocities can approach supersonic speeds and the first internal beam 328a (gas jet) is created between the first nozzle 331a and the skimmer opening 312. In addition, the second gas composition can be introduced into the second gas transition element 333b and can be ejected into the substantially lower pressure vacuum in the partially-open process space 341 through the second nozzle 331b. When the second high-pressure condensable gas from the second nozzle 331b expands into the lower pressure region of the partially-open process space 341, the gas molecule velocities can approach supersonic speeds and the second internal beam 328b (gas jet) is created between the second nozzle 331b and the skimmer opening 312. Furthermore, a third gas composition can be introduced into the third gas transition element 333c and can be ejected into the substantially lower pressure vacuum in the partially-open process space 341 through the third nozzle 331c. When the third high-pressure condensable gas from the third nozzle 331c expands into the lower pressure region of the partially-open process space 341, the gas molecule velocities can approach supersonic speeds and the third internal beam 328c (gas jet) is created between the third nozzle 331c and the skimmer opening 312. Then, an external MBGCB 339 of multi-gas clusters can emanate from the first outer shaping element 313 and the second outer shaping element 315 in the PMNS module 340.

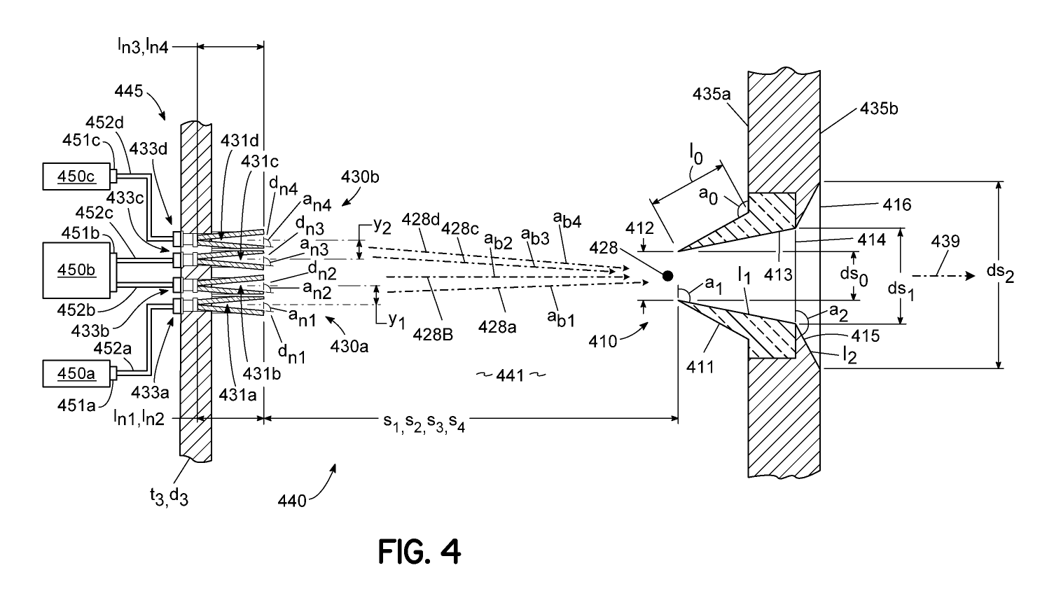

FIG. 4 illustrates a partial block diagram of another exemplary PMNS having four nozzles in accordance with embodiments of the invention. The illustrated partial PMNS module 440 comprises nozzle assembly structure 445 to which is removably coupled a first dual nozzle assembly 430a with first and second nozzles 431a and 431b, and a second dual nozzle assembly 430b with third and fourth nozzles 431c and 431d. PMNS module 440 further comprises a skimmer subassembly 410 having an inner element 411, a first outer shaping element 413, and a second outer shaping element 415. The first outer shaping element 413 can extend from a skimmer opening 412 outwardly to a first circular opening 414 of diameter ds1 adjacent to or inside of an external wall 435b of the base flange assembly 435. The second outer shaping element 415 can extend from the first circular opening 414 outwardly to a second circular opening 416 of diameter ds2 that intersects with the external wall 435b.

Inner element 411 can be coupled to an inner wall 435a, and can have a length (l₀) and an angle (a₀). The length (l₀) of the inner element 411 measured from the inner wall 435a to the skimmer opening 412 can vary from about 20 mm to about 40 mm, and the angle (a₀) from the inner wall 435a can vary from about 100 degrees to about 175 degrees. Skimmer opening 412 can have a diameter ds₀, which can vary from about 0.5 mm to about 5.0 mm. The diameter (ds₀), the length (l₀) and the angle (a₀) can be dependent upon the desired width for a MBGCB 439, the gas cluster size, and the process chemistry (gases) that the PMNS module 440 is designed to create. Alternatively, the inner element 411 and/or the skimmer opening 412 may be configured differently.

A first length (l₁) and a first angle (a₁) can be associated with the first outer shaping element 413, and a second length (l₂) and a second angle (a₂) can be associated with the second outer shaping element 415. The first length (l₁) can vary from about 20 mm to about 40 mm, and the first angle (a₁) can vary from about 95 degrees to about 175 degrees. The second length (l₂) can vary from about 10 mm to about 30 mm, and the second angle (a₂) can vary from about 100 degrees to about 175 degrees. The first length (l₁), the first angle (a₁), the second length (l₂), and the second angle (a₂) can be dependent upon the desired width for internal beams 428a-428d, the MBGCB 439, the gas cluster size, and the process chemistry (gases) that the PMNS module 440 is designed to create. Alternatively, the outer shaping elements 413 and 414 may be configured differently or may not be required.

In other embodiments, the skimmer subassemblies 110 (FIG. 1), 210 (FIG. 2), or 310 (FIG. 3) may be used to replace the skimmer subassembly 410.

The output of the first nozzle 431a can be separated from the skimmer opening 412 by a first separation distance (s₁) that can vary from about 10 mm to about 50 mm. The output of the second nozzle 431b can be separated from the skimmer opening 412 by a second separation distance (s₂) that can vary from about 10 mm to about 50 mm. In addition, the output of the third nozzle 431c can be separated from the skimmer opening 412 by a third separation distance (ₛ₃) that can vary from about 10 mm to about 50 mm. Furthermore, the output of the fourth nozzle 431d can be separated from the skimmer opening 412 by a fourth separation distance (s₄) that can vary from about 10 mm to about 50 mm.

Alternatively, other separation distances (s₁), (s₂), (s₃), and (s₄) may be used. In use, a first internal beam 428a (gas jet) is created at a first beam angle (a_{b1}) from the first nozzle 431a of the first dual nozzle assembly 430a and is aligned with and directed towards the beam summation point 428 proximate to the skimmer opening 412 in the skimmer subassembly 410. A second internal beam 428b (gas jet) is created at a second beam angle (a_{b2}) from the second nozzle 431b of the first dual nozzle assembly 430a and is aligned with and directed towards the beam summation point 428 proximate to the skimmer opening 412 in the skimmer subassembly 410. In addition, a third internal beam 428c (gas jet) is created at a third beam angle (a_{b3}) from the third nozzle 431c of the second dual nozzle assembly 430b and is aligned with and directed towards the beam summation point 428 proximate to the skimmer opening 412 in the skimmer subassembly 410. Furthermore, a fourth internal beam 428c (gas jet) is created at a fourth beam angle (a_{b4}) from the fourth nozzle 431c of the second dual nozzle assembly 430b and is aligned with and directed towards the beam summation point 428 proximate to the skimmer opening 412 in the skimmer subassembly 410. Alternatively, the nozzles 431a, 431b, 431c, and 431d may be configured differently. For example, the beam angles (a_{b1}, a_{b2}, a_{b3}, and a_{b4}) can vary from about −15 degrees to about +15 degrees from a horizontal reference.

The first and second nozzles 431a, 431b of the first dual nozzle assembly 430a can have first and second nozzle lengths (lₙ₁ and lₙ₂), first and second nozzle opening angles (aₙ₁ and aₙ₂), and first and second nozzle diameters (dₙ₁ and dₙ₂). The first and second nozzle lengths (lₙ₁ and lₙ₂) can each vary from about 20 mm to about 40 mm; the first and second nozzle opening angles (aₙ₁ and aₙ₂) can each vary from about 90.5 degrees to about 105 degrees; and the first and second nozzle diameters (dₙ₁ and dₙ₂) can each vary from about 2 mm to about 4 mm. In addition, a first separation distance (y₁) can be established between the first nozzle 431a and the second nozzle 431b (measured from the center lines), and the first separation distance (y₁) can vary from about 5 mm to about 25 mm.

The third and fourth nozzles 431c, 431d of the second dual nozzle assembly 430b can have third and fourth nozzle lengths (lₙ₃ and lₙ₄), third and fourth nozzle opening angles (aₙ₃ and aₙ₄), and third and fourth nozzle diameters (dₙ₃ and dₙ₄). The third and fourth nozzle lengths (lₙ₃ and lₙ₄) can each vary from about 20 mm to about 40 mm; the third and fourth nozzle opening angles (aₙ₁ and aₙ₄) can each vary from about 90.5 degrees to about 105 degrees; and the third and fourth nozzle diameters (dₙ₃ and dₙ₄) can each vary from about 2 mm to about 4 mm. In addition, a second separation distance (y₂) can be established between the third nozzle 431c and the fourth nozzle 431d (measured from the center lines), and the second separation distance (y₂) can vary from about 5 mm to about 25 mm.

The MBGCB 439 of the PMNS module 440 can be aligned in the x-direction, the y-direction, and the z-direction before PMNS module 440 is mounted to the chamber wall. Alternatively, one or more mechanical positioning devices (not shown) may be used.

When the PMNS module 440 is aligned and/or tested, the skimmer subassembly 410 can be aligned with the first and second nozzles 431a and 431b in the first dual nozzle assembly 430a and with the third and fourth nozzles 431c and 431d in the second dual nozzle assembly 430b. A first internal beam 428a can be established using the first nozzle 431a, a second internal beam 428b can be established using the second nozzle 431b, a third internal beam 428c can be established using the third nozzle 431c, and a fourth internal beam 428d can be established using the fourth nozzle 431d. The internal beams 428a, 428b, 428c, and 428d can be aligned with and directed towards the skimmer opening 412 in the skimmer subassembly 410.

In some embodiments, the first and second nozzles 431a and 431b in the first dual nozzle assembly 430a and the third and fourth nozzles 431c and 431d in the second dual nozzle assembly 430b can be pre-tested and/or pre-aligned before being used. The nozzles 431a, 431b, 431c, and 431d can be configured differently, and the differences can be determined by the process chemistry, the molecule size, the flow rate, the chamber pressure, the cluster size, the beam size, etc. In addition, one or more pre-tested and/or pre-aligned dual nozzle assemblies 430a and/or 430b can be stored on-site to facilitate the use of other process recipes.

In some embodiments, the first nozzle 431a can be coupled to a first gas transition element 433a, the second nozzle 431b can be coupled to a second gas transition element 433b, the third nozzle 431c can be coupled to a third gas transition element 433c, and the fourth nozzle 431d can be coupled to a fourth gas transition element 433d. The first gas transition element 433a can be configured to provide a first process gas to the first nozzle 431a at a first controlled flow rate, the second gas transition element 433b can be configured to provide a second process gas to the second nozzle 431b at a second controlled flow rate, the third gas transition element 433c can be configured to provide a third process gas to the third nozzle 431c at a third controlled flow rate, and the fourth gas transition element 433d can be configured to provide a fourth process gas to the fourth nozzle 431d at a fourth controlled flow rate.

A first gas feed tube 452a can be coupled to the first gas transition element 433a, a second gas feed tube 452b can be coupled to the second gas transition element 433b, a third gas feed tube 452c can be coupled to the third gas transition element 433c, and a fourth gas feed tube 452d can be coupled to the fourth gas transition element 433d.

A first gas control unit 451a can be coupled to the first gas feed tube 452a and to a first gas supply system 450a, a second gas control unit 451b can be coupled to the second gas feed tube 452b, the third gas feed tube 452c, and to a second gas supply system 450b, and a third gas control unit 451c can be coupled to the fourth gas feed tube 452d and to a third gas supply system 450c. For example, the gas transition elements 433a, 433b, 433c, and 433d can be used to removably couple the PMNS module 440 to the gas supply systems 450a, 450b, and 450c.

In some alignment tests, an optical input signal from an optical test source can be provided through one of the gas transition elements 433a, 433b, 433c, and 433d, and an optical output signal can be measured at the output of the respective nozzle 431a, 431b, 431c, or 431d, or at the skimmer opening 412, or at the beam summation point 428 using an optical receiver. In this manner, the alignment of the internal beams 428a, 428b, 428c, or 428d and the position of the beam summation point 428 can be optically tested and verified. Alternatively, the beam summation point 428 may not be required.

The gas transition elements 433a, 433b, 433c, and 433d can include flow control devices, filters, and valves as required and can be used to control the flow rate of the processing gases into the nozzles 431a, 431b, 431c, and 431d. For example, the flow rates can vary from about 10 sccm to about 5000 sccm. The gas control units 451a, 451b, and 451c can control the gas compositions from the gas supply subsystems 450a, 450b, and 450c. For example, a first gas composition stored in the first gas supply subsystem 450a, a second gas composition stored in the second gas supply subsystem 450b, and/or a third gas composition stored in the third gas supply subsystem 450c can be used when the PMNS module 440 is being aligned and/or tested or when it is being used in a MBGCIB production process.

In some examples, one or more of the gas supply subsystems 450a, 450b, and 450c can be configured to use a condensable inert gas that can include a noble gas, i.e., He, Ne, Ar, Kr, Xe, or Rn. In addition, one or more of the gas supply subsystems 450a, 450b, and 450c can be configured to use a film forming gas composition, an etching gas composition, a cleaning gas composition, a smoothing gas composition, etc. Furthermore, the gas supply subsystems 450a, 450b, and 450c may be utilized either alone or in combination with one another when the PMNS module 440 is configured to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof.

During alignment, testing, and/or MBGCIB processing, the gas supply subsystems 450a, 450b, and 450c can provide one or more gas compositions to the PMNS module 440 at a high pressure to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof. For example, the first gas composition can be introduced into the first gas transition element 433a and can be ejected into the substantially lower pressure vacuum in the partially-open process space 441 through the first nozzle 431a. When the first high-pressure condensable gas from the first nozzle 431a expands into the lower pressure region of the partially-open process space 441, the gas molecule velocities can approach supersonic speeds and the first internal beam 428a (gas jet) is created between the first nozzle 431a and the skimmer opening 412. In addition, the second gas composition can be introduced into the second and/or third gas transition elements 433b and/or 433c and can be ejected into the substantially lower pressure vacuum in the partially-open process space 441 through the second and/or third nozzles 431b and/or 431c. When the second high-pressure condensable gas from the nozzles 431b and/or 431c expands into the lower pressure region of the partially-open process space 441, the gas molecule velocities can approach supersonic speeds and the second and/or third internal beams 428b and/or 428c (gas jet) are created between nozzles 431b and/or 431c and the skimmer opening 412. Furthermore, a third gas composition can be introduced into the fourth gas transition element 433d and can be ejected into the substantially lower pressure vacuum in the partially-open process space 441 through the fourth nozzle 431d. When the third high-pressure condensable gas from the fourth nozzle 431d expands into the lower pressure region of the partially-open process space 441, the gas molecule velocities can approach supersonic speeds and the fourth internal beam 428d (gas jet) is created between the fourth nozzle 431d and the skimmer opening 412. Then, an external MBGCB 439 of multi-gas clusters can emanate from the first outer shaping element 413 and the second outer shaping element 415 in the PMNS module 440.

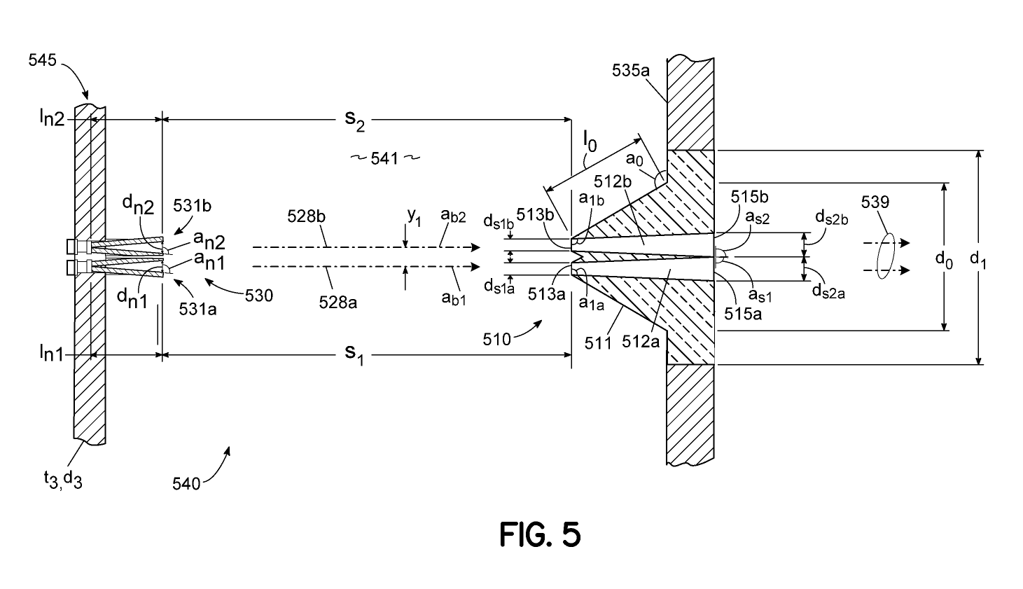

FIG. 5 illustrates a partial block diagram of an additional exemplary PMNS having a dual nozzle assembly and a dual skimmer assembly in accordance with embodiments of the invention. The illustrated partial PMNS module 540 comprises nozzle assembly structure 545 to which is removably coupled a dual nozzle assembly 530 with first and second nozzles 531a and 531b, and a dual skimmer subassembly 510 with first and second skimmers 512a and 512b.

The dual skimmer subassembly 510 has an inner element 511 that has an inner diameter d₀, a length l₀, a shaping angle a₀ and an outer diameter d₁. The inner diameter d₀ can vary from about 10 mm to about 20 mm, the shaping angle a₀ can vary from about 100 degrees to about 175 degrees, and the outer diameter d₁ can vary from about 20 mm to about 30 mm. The inner element 511 can be coupled to an inner wall 535a, and the first length (l₀), measured from the inner wall 535a to the first skimmer openings 513a, b can vary from about 20 mm to about 30 mm.

The dual skimmer subassembly 510 can comprise a first skimmer element 512a that can have a first skimmer opening 513a, and a first skimmer output 515a. The first skimmer opening 513a can have a diameter (dₛ₁ₐ) that can vary from about 2 mm to about 5 mm, and the first skimmer output 515a can have a diameter (dₛ₂ₐ) that can vary from about 3 mm to about 6 mm. A first skimmer length lₛ₁ can extend from the first skimmer opening 513a outwardly to the first skimmer output 515a, and the first skimmer length lₛ₁ can vary from about 20 mm to about 40 mm. The first skimmer element 512a can have a first shaping angle as1 that can vary from about 92 degrees to about 100 degrees and can have a first external angle a₁ₐ that can vary from about 20 degrees to about 40 degrees.

The diameter (dₛ₁ₐ) of the first skimmer opening 513a, the diameter (dₛ₂ₐ) of the first skimmer output 515a, the first skimmer length lₛ₁, first shaping angle aₛ₁ and the first external angle a₁ₐ can be dependent upon the desired width for a MBGCB 539, the gas cluster size, and the process chemistry (gases) that the PMNS module 540 is designed to create. Alternatively, the first skimmer element 512a, the first skimmer length ls₁, the first skimmer opening 513a, and/or the first skimmer output 515a may be configured differently or may not be required.

The dual skimmer subassembly 510 can comprise a second skimmer element 512b that can have a second skimmer opening 513b, and a second skimmer output 515b. The second skimmer opening 513b can have a diameter (d_{s1b}) that can vary from about 2 mm to about 5 mm, and the second skimmer output 515b can have a diameter (d_{s2b}) that can vary from about 3 mm to about 6 mm. A second skimmer length ls₂ can extend from the second skimmer opening 513b outwardly to the second skimmer output 515b, and the second skimmer length ls₂ can vary from about 20 mm to about 40 mm. The second skimmer element 512b can have a second shaping angle aₛ₂ that can vary from about 92 degrees to about 100 degrees and can have a second external angle a1b that can vary from about 20 degrees to about 40 degrees.

The diameter (d_{s1b}) of the second skimmer opening 513b, the diameter (d_{s2b}) of the second skimmer output 515b, the second skimmer length ls₂, second shaping angle as2 and the second external angle a1b can be dependent upon the desired width for a MBGCB 539, the gas cluster size, and the process chemistry (gases) that the PMNS module 540 is designed to create. Alternatively, the second skimmer element 512b, the second skimmer length ls₂, the second skimmer opening 513b, and/or the second skimmer output 515b may be configured differently or may not be required.

The output of the first nozzle 531a can be separated from the first skimmer opening 513a by a first separation distance (s₁) that can vary from about 10 mm to about 50 mm. The output of the second nozzle 531b can be separated from the second skimmer opening 513b by a second separation distance (s₂) that can vary from about 10 mm to about 50 mm. Alternatively, other separation distances (s₁) and (s₂) may be used.

In use, a first internal beam 528a (gas jet) is created at a first beam angle (a_{b1}) from the first nozzle 531a of the dual nozzle assembly 530 and is aligned with and directed towards the first skimmer opening 513a in the dual skimmer subassembly 510. A second internal beam 528b (gas jet) is created at a second beam angle (a_{b2}) from the second nozzle 531b of the dual nozzle assembly 530 and is aligned with and directed towards the second skimmer opening 513b in the dual skimmer subassembly 510. For example, the beam angles (a_{b1} and a_{b2}) can vary from about −15 degrees to about +15 degrees from a horizontal reference.

The first and second nozzles 531a, 531b of the dual nozzle assembly 530 can have first and second nozzle lengths (lₙ₁ and lₙ₂), first and second nozzle opening angles (aₙ₁ and aₙ₂), and first and second nozzle diameters (dₙ₁ and dₙ₂). The first and second nozzle lengths (lₙ₁ and lₙ₂) can each vary from about 20 mm to about 40 mm; the first and second nozzle opening angles (aₙ₁ and aₙ₂) can each vary from about 90.5 degrees to about 105 degrees; and the first and second nozzle diameters (dₙ₁ and dₙ₂) can each vary from about 2 mm to about 4 mm. In addition, a first separation distance (y₁) can be established between the first nozzle 531a and the second nozzle 531b (measured from the center lines), and the first separation distance (y₁) can vary from about 5 mm to about 25 mm.

The MBGCB 539 of the PMNS module 540 can be aligned in the x-direction, the y-direction, and the z-direction before PMNS module 540 is mounted to the chamber wall. Alternatively, one or more mechanical positioning devices (not shown) may be used.

When the PMNS module 540 is aligned and/or tested, the dual skimmer subassembly 510 can be aligned with the first and second nozzles 531a and 531b in the dual nozzle assembly 530. A first internal beam 528a can be established using the first nozzle 531a, and a second internal beam 528b can be established using the second nozzle 531b. The internal beams 528a and 528b can be aligned with and directed towards the first and second skimmer openings 513a, 513b, respectively, in the dual skimmer subassembly 510.

In some embodiments, the first and second nozzles 531a and 531b in the dual nozzle assembly 530 can be pre-tested and/or pre-aligned before being used. The nozzles 531a, 531b can be configured differently, and the differences can be determined by the process chemistry, the molecule size, the flow rate, the chamber pressure, the cluster size, the beam size, etc. In addition, one or more pre-tested and/or pre-aligned dual nozzle assemblies 530 can be stored on-site to facilitate the use of other process recipes.

In some embodiments, the first nozzle 531a can be coupled to a first gas transition element (not shown) and the second nozzle 531b can be coupled to a second gas transition element (not shown). The first and second gas transition elements can be configured to provide first and second process gases to the first and second nozzles 531a, 531b, respectively, at first and second controlled flow rates. Gas feed tubes (not shown) can be coupled to the gas transition elements (not shown), and gas control units (not shown) can be coupled to the gas feed tubes and to gas supply systems (not shown), as described in reference to FIG. 2.

In some alignment tests, an optical input signal from an optical test source can be provided through one of the gas transition elements and an optical output signal can be measured at the output of the respective nozzle 531a, 531b, or at the skimmer openings 513a, b using an optical receiver. In this manner, the alignment of the internal beams 528a, 528b can be optically tested and verified.

The gas transition elements can include flow control devices, filters, and valves as required and can be used to control the flow rate of the processing gases into the nozzles 531a, 531b. For example, the flow rates can vary from about 10 sccm to about 5000 sccm. The gas control units can control the gas compositions from the gas supply systems. For example, a first gas composition stored in a first gas supply system and/or a second gas composition stored in a second gas supply system can be used when the PMNS module 540 is being aligned and/or tested or when it is being used in a MBGCIB production process.

In some examples, one or more of the gas supply systems can be configured to use a condensable inert gas that can include a noble gas, i.e., He, Ne, Ar, Kr, Xe, or Rn. In addition, one or more of the gas supply subsystems 550a, 550b, and 550c can be configured to use a film forming gas composition, an etching gas composition, a cleaning gas composition, a smoothing gas composition, etc. Furthermore, the gas supply systems may be utilized either alone or in combination with one another when the PMNS module 540 is configured to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof.

During alignment, testing, and/or MBGCIB processing, the gas supply systems can provide one or more gas compositions to the PMNS module 540 at a high pressure to produce ionized multi-gas clusters comprising helium, neon, argon, krypton, xenon, nitrogen, oxygen, hydrogen, methane, nitrogen trifluoride, carbon dioxide, sulfur hexafluoride, nitric oxide, or nitrous oxide, or any combination of two or more thereof. For example, the first gas composition can be introduced into a first gas transition element and can be ejected into the substantially lower pressure vacuum in the partially-open process space 541 through the first nozzle 531a. When the first high-pressure condensable gas from the first nozzle 531a expands into the lower pressure region of the partially-open process space 541, the gas molecule velocities can approach supersonic speeds and the first internal beam 528a (gas jet) is created between the first nozzle 531a and the first skimmer opening 513a. In addition, the second gas composition can be introduced into a second gas transition element and can be ejected into the substantially lower pressure vacuum in the partially-open process space 541 through the second nozzles 531b. When the second high-pressure condensable gas from the nozzle 531b expands into the lower pressure region of the partially-open process space 541, the gas molecule velocities can approach supersonic speeds and the second internal beam 528b (gas jet) is created between nozzle 531b and the second skimmer opening 513b. Then, an external MBGCB 539 of multi-gas clusters can emanate from the first and second skimmer outputs 515a, b in the PMNS module 540.

The dual skimmer subassembly 510 may likewise be used in the PMNS modules 340 and 440 in FIGS. 3 and 4 in place of the skimmer subassemblies 310, 410 depicted. For example, the first and second internal beams 328a, 328b established from dual nozzle assembly 330a can be aligned and directed toward first skimmer opening 513a, which may have the beam summation point 328 proximate thereto, and the third internal beam 328c established from single nozzle assembly 330b can be aligned and directed toward second skimmer opening 513b. Likewise, the first and second internal beams 428a, 428b established from first dual nozzle assembly 430a can be aligned and directed toward first skimmer opening 513a, which may have the beam summation point 428 proximate thereto, and the third and fourth internal beams 428c, 428d established from second dual nozzle assembly 430b can be aligned and directed toward second skimmer opening 513b, which may have another beam summation point proximate thereto. Thus, various combinations of single and dual nozzle assemblies and single or dual skimmer assemblies may be used in a PMNS module of the invention.

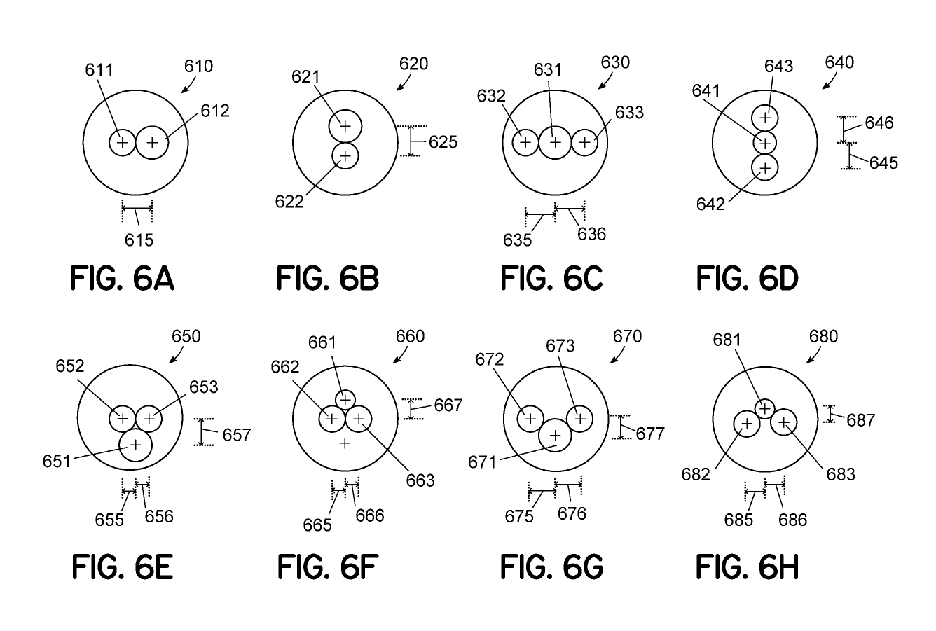

FIGS. 6A-6H illustrate a variety of multi-nozzle configurations in accordance with embodiments of the invention. For example, the multi-nozzles configurations shown in FIGS. 6A-6H can be used in the PMNS modules 140, 240, 340, 440 and/or 540 or in other PMNS modules (not shown).

A first nozzle configuration 610 is shown in FIG. 6A having a first nozzle opening 611 and a second nozzle opening 612. The second nozzle opening 612 is shown larger than the first nozzle opening 611 and is separated from the first nozzle opening 611 by a first distance 615 in a first direction (measured from the center lines, depicted with cross-hairs). Alternatively, other sizes and configurations may be used.

A second nozzle configuration 620 is shown in FIG. 6B having a first nozzle opening 621 and a second nozzle opening 622. The second nozzle opening 622 is shown smaller than the first nozzle opening 621 and is separated from the first nozzle opening 621 by a second distance 625 in a second direction. Alternatively, other sizes and configurations may be used.

A third nozzle configuration 630 is shown in FIG. 6C having a first nozzle opening 631, a second nozzle opening 632, and a third nozzle opening 633. The first nozzle opening 631 is shown larger than second nozzle opening 632 and the third nozzle opening 633. The first nozzle opening 631 is separated from the second nozzle opening 632 by a first distance 635 in a first direction and is separated from the third nozzle opening 633 by a second distance 636 in the first direction. Alternatively, other sizes and configurations may be used.

A fourth nozzle configuration 640 is shown in FIG. 6D having a first nozzle opening 641, a second nozzle opening 642, and a third nozzle opening 643. The first nozzle opening 641 is shown smaller than second nozzle opening 642 and the third nozzle opening 643. The first nozzle opening 641 is separated from the second nozzle opening 642 by a first distance 645 in a second direction and is separated from the third nozzle opening 633 by a second distance 646 in the second direction. Alternatively, other sizes and configurations may be used.

A fifth nozzle configuration 650 is shown in FIG. 6E having a first nozzle opening 651, a second nozzle opening 652, and a third nozzle opening 653. The first nozzle opening 651 is shown larger than second nozzle opening 652 and the third nozzle opening 653. The first nozzle opening 651 is separated from the second nozzle opening 652 by a first distance 655 in a first direction and is separated from the third nozzle opening 653 by a second distance 656 in the first direction. The first nozzle opening 651 is separated from the second nozzle opening 652 and the third nozzle opening 653 by a third distance 657 in a second direction. Alternatively, other sizes and configurations may be used.

A sixth nozzle configuration 660 is shown in FIG. 6F having a first nozzle opening 661, a second nozzle opening 662, and a third nozzle opening 663. The first nozzle opening 661 is shown smaller than second nozzle opening 662 and the third nozzle opening 663. The first nozzle opening 661 is separated from the second nozzle opening 662 by a first distance 665 in a first direction and is separated from the third nozzle opening 663 by a second distance 666 in the first direction. The first nozzle opening 661 is separated from the second nozzle opening 662 and the third nozzle opening 663 by a third distance 667 in a second direction. Alternatively, other sizes and configurations may be used.

A seventh nozzle configuration 670 is shown in FIG. 6G having a first nozzle opening 671, a second nozzle opening 672, and a third nozzle opening 673. The first nozzle opening 671 is shown larger than second nozzle opening 672 and the third nozzle opening 673. The first nozzle opening 671 is separated from the second nozzle opening 672 by a first distance 675 in a first direction and is separated from the third nozzle opening 673 by a second distance 676 in the first direction. The first nozzle opening 671 is separated from the second nozzle opening 672 and the third nozzle opening 673 by a third distance 677 in a second direction. Alternatively, other sizes and configurations may be used.

An eighth nozzle configuration 680 is shown in FIG. 6H having a first nozzle opening 681, a second nozzle opening 682, and a third nozzle opening 683. The first nozzle opening 681 is shown smaller than second nozzle opening 682 and the third nozzle opening 683. The first nozzle opening 681 is separated from the second nozzle opening 682 by a first distance 685 in a first direction and is separated from the third nozzle opening 683 by a second distance 686 in the first direction. The first nozzle opening 681 is separated from the second nozzle opening 682 and the third nozzle opening 683 by a third distance 687 in a second direction. Alternatively, other sizes and configurations may be used.

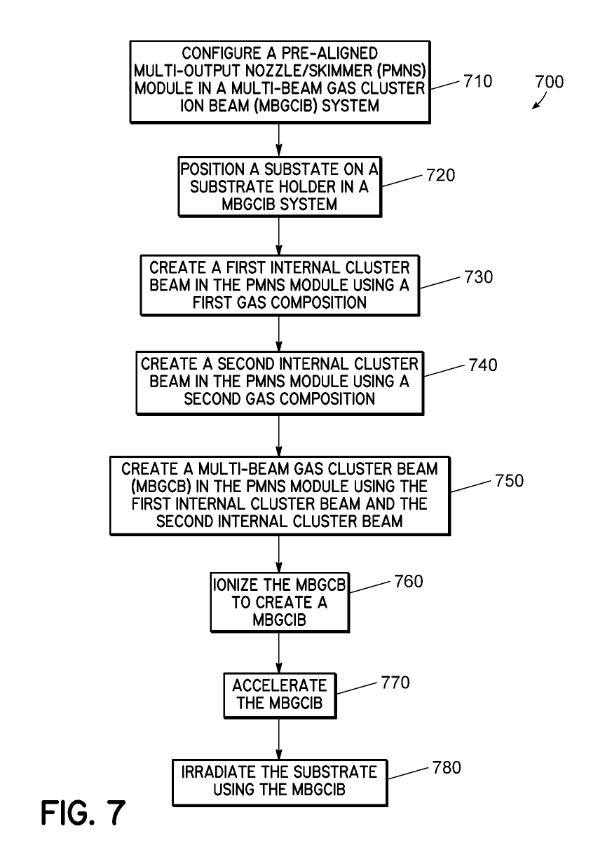

FIG. 7 illustrates a flow chart of a method for irradiating a substrate using a pre-aligned multi-output nozzle/skimmer (PMNS) module in a multi-beam gas cluster ion beam (MBGCIB) system in accordance with embodiments of the invention. A flow chart is used to explain procedure 700, which uses PMNS module in a gas cluster ion beam (GCIB) system for creating a MBGCIB for irradiating substrates to dope, grow, deposit, or modify layers on a substrate.

In 710, a PMNS module can be configured in a MBGCIB processing system. In some examples, the PMNS module can have at least two nozzle assemblies (e.g., a dual nozzle assembly) configured in mutual close proximity to ensure coalescence of individual gas cluster beams at a beam summation point proximate to a skimmer opening in an internal gas skimmer. In other examples, the PMNS module can have at least two nozzle assemblies configured in mutual close proximity to ensure coalescence of individual gas cluster beams at a beam summation point proximate to a skimmer output in an internal gas skimmer.

Some MBGCIB systems can include a first gas supply subsystem that is coupled to a first nozzle assembly, and a second gas supply subsystem that is coupled to a second nozzle assembly. The first nozzle assembly can include a first cylindrical mixing space and a first nozzle that can be coupled to a first gas supply subsystem, and the second nozzle assembly can include a second cylindrical mixing space and a second nozzle that can be coupled to a second gas supply subsystem. The first nozzle assembly can create a first internal beam using a first gas composition from the first gas supply subsystem, and the second nozzle assembly can create a second internal beam using a second gas composition from the second gas supply subsystem.

For example, the PMNS module can be configured as shown in FIGS. 1-4, and the nozzles openings can be configured as shown in FIGS. 6A-6H. Alternatively, other PMNS and nozzle configurations may be used.

In 720, a substrate can be loaded into the MBGCIB system (e.g., 200 in FIG. 2). The substrate can include a conductive material, a non-conductive material, or a semi-conductive material, or a combination of two or more thereof. Additionally, the substrate may include one or more material structures formed thereon, or the substrate may be a blanket substrate free of material structures. The substrate can be positioned in the MBGCIB processing system on a substrate holder and may be securely held by the substrate holder. The temperature of the substrate may or may not be controlled. For example, the substrate may be heated or cooled during a film forming process. The environment surrounding the substrate is maintained at a reduced pressure.

In 730, a first flow of a first gas mixture can be provided from the first gas supply system to the first nozzle assembly to create a first internal gas cluster beam that is directed towards the beam summation point in the PMNS module. For example, the flow of gas through the first nozzle or a group of first nozzles connected to the first gas supply system can form a first gas cluster beam or a first coalesced and/or first intersected gas cluster beam that is directed towards the beam summation point, and a single multi-gas beam passes from the beam summation point through the internal skimmer into the ionization chamber of the MBGCIB processing system.

In 740, a second flow of a second gas mixture can be provided from the second gas supply system to the second nozzle assembly to create a second internal gas cluster beam that is directed towards the beam summation point in the PMNS module. Alternatively, the second gas mixture can be introduced from an optional second gas supply into all or a subset of the remaining nozzles (i.e. nozzles not coupled to the first gas supply system. The optional second gas mixture may be the same or different than the first gas mixture, and the gas mixtures, if different, may be incompatible.

For example, the flow of gas through the second nozzle or a group of second nozzles connected to the second gas supply system can form a second gas cluster beam or a second coalesced and/or second intersected gas cluster beam that is directed towards the beam summation point, and a single multi-gas beam passes from the beam summation point through the internal skimmer into the ionization chamber of the MBGCIB processing system.

In 750, a Multi-Beam Gas Cluster Beam (MBGCB) can be created at the beam summation point and can exit from the skimmer assembly in the PMNS module.

In 760, the MBGCB can pass through an ionizer wherein the MBGCB is ionized to create a Multi-Beam Gas Cluster Ion Beam (MBGCIB).

In 770, the MBGCIB can be accelerated by applying a beam acceleration potential to the MBGCIB.

In 780, the MBGCIB composed of the first gas mixture and the second gas mixture is used to irradiate the substrate loaded in the MBGCIB processing system.

The beam acceleration potential and the beam dose can be selected to achieve the desired properties of a layer affected by irradiation with the MBGCIB, on the substrate. For example, the beam acceleration potential and the beam dose can be selected to control the desired thickness of a deposited or grown layer, or to achieve a desired surface roughness or other modification of an upper layer atop the substrate, or to control the concentration and depth of penetration of a dopant into the substrate. Herein, beam dose is given the units of number of clusters per unit area. However, beam dose may also include beam current and/or time (e.g., MBGCIB dwell time). For example, the beam current may be measured and maintained constant, while time is varied to change the beam dose. Alternatively, the rate at which clusters irradiate the surface of the substrate per unit area (i.e., number of clusters per unit area per unit time) may be held constant while the time is varied to change the beam dose.

Additionally, other MBGCIB properties may be varied, including, but not limited to, gas flow rates, stagnation pressures, cluster size, or gas nozzle designs (such as nozzle throat diameter, nozzle length, and/or nozzle divergent section half-angle).

The selection of combinations of gases used for the first and second gas mixtures depends on the process that the substrate is being subjected to. The deposition or growth of a material layer may include depositing or growing a SiOₓ, SiNₓ, SiCₓ, SiCₓO_{y}, SiCₓN_{y}, BNₓ, BSiₓN_{y}, Ge, SiGe(B), or SiC(P) layer on a substrate or atop an existing layer on a substrate. According to embodiments of the invention, the first or the second gas mixture may thus comprise a nitrogen-containing gas, a carbon-containing gas, a boron-containing gas, a silicon-containing gas, a phosphorous-containing gas, a sulfur-containing gas, a hydrogen-containing gas, a silicon-containing gas, or a germanium-containing gas, or a combination of two or more thereof. Examples of gases which may be used to form the first and second gas mixtures are: He, Ne, Ar, Kr, Xe, Rn, SiH₄, Si₂H₆, C₄H₁₂S₁, C₃H₁₀S₁, H₃C—SiH₃, H₃C—SiH₂—CH₃, (CH₃)₃—SiH, (CH₃)₄—Si, SiH₂Cl₂, SiCl₃H, SiCl₄, SiF₄, O₂, CO, CO₂, N₂, NO, NO₂, N₂O, NH₃, NF₃, B₂H₆, alkyl silane, an alkane silane, an alkene silane, an alkyne silane, and CₓH_{y}, where x>1, and y>4, and combinations of two or more thereof. The first and second gas mixtures are formed by the first and second gas supply systems of the MBGCIB processing system.

When depositing silicon, a substrate may be irradiated by a MBGCIB formed from first or second gas mixtures, at least one of which comprises a silicon-containing gas. For example, a gas mixture may comprise silane (SiH₄). In another example, the gas mixture may comprise disilane (Si₂H₆), dichlorosilane (SiH₂Cl₂), trichlorosilane (SiCl₃H), diethylsilane (C₄H₁₂Si), trimethylsilane (C₃H₁₀Si), silicon tetrachloride (SiCl₄), silicon tetrafluoride (SiF₄), or a combination of two or more thereof. The second gas mixture may comprise a noble gas, for example.

When depositing or growing an oxide such as SiOx, a substrate may be irradiated by a MBGCIB formed from first and second gas mixtures having a silicon-containing gas and an oxygen-containing gas, respectively. For example, the first gas mixture may comprise silane (SiH₄), and the second gas mixture may comprise O₂. In another example, the second gas mixture may comprise O₂, CO, CO₂, NO, NO₂, or N₂O, or any combination of two or more thereof.

When depositing or growing a nitride such as SiNx, a substrate may be irradiated by a MBGCIB formed from first and second gas mixtures having a silicon-containing gas and a nitrogen-containing gas, respectively. For example, the first gas mixture may comprise silane (SiH₄), and the second gas mixture may comprise N₂. In another example, the second gas mixture may comprise O₂, CO, CO₂, NO, NO₂, or N₂O, or any combination of two or more thereof.

When depositing a carbide such as SiCₓ, a substrate may be irradiated by a MBGCIB formed from first and second gas mixtures having a silicon-containing gas and a carbon-containing gas. For example, the first gas mixture may comprise silane (SiH₄) and CH₄. Alternatively, the first gas mixture may comprise silane (SiH₄) only, and the second gas mixture may comprise CH₄. Additionally, for example, the first gas mixture may comprise silane (SiH₄), and the second gas mixture may comprise methylsilane (H₃C—SiH₃). Furthermore, for example, the first gas mixture may comprise a silicon-containing gas and CH₄ (or more generally a hydrocarbon gas, i.e., CₓH_{y}), and the second gas mixture may comprise CO, or CO₂. Further yet, the first gas mixture and/or the second gas mixture may comprise, for example, alkyl silane, an alkane silane, an alkene silane, or an alkyne silane, or any combination of two or more thereof. Additionally, for example, the first gas mixture and/or the second gas mixture may comprise silane, methylsilane (H₃C—SiH₃), dimethylsilane (H₃C—SiH₂—CH₃), trimethylsilane ((CH₃)₃—SiH), or tetramethylsilane ((CH₃)₄—Si), or any combination of two or more thereof.

When growing or depositing a carbonitride such as SiCₓN_{y}, the second gas mixture may further comprise a nitrogen-containing gas. For example, the nitrogen-containing gas may include N₂, NH₃, NF₃, NO, N₂O, or NO₂, or a combination of two or more thereof. The addition of a nitrogen-containing gas may permit forming a silicon carbonitride film (SiCN).

When growing or depositing a nitride such as BNx, a substrate may be irradiated by a MBGCIB formed from a first gas mixture having a boron-containing gas and a second gas mixture having a nitrogen-containing gas. For example, the first gas mixture may comprise diborane (B₂H₆), and the second gas mixture may comprise N₂. In another example, the second gas mixture may comprise N₂, NO, NO₂, N₂O, or NH₃, or any combination of two or more thereof.

When growing or depositing a nitride such as BSiₓN_{y}, a substrate may be irradiated by a MBGCIB formed from a first gas mixture having a silicon-containing gas, and a second gas mixture having a boron-containing gas and a nitrogen-containing gas. For example, the first gas mixture may comprise silane (SiH₄), and the second gas mixture may comprise diborane (B₂H₆) and N₂. In another example, the second gas mixture may comprise B₂H₆, N₂, NO, NO₂, N₂O, or NH₃, or any combination of two or more thereof.

In other processes, such as for example, infusion, doping, and layer surface modification, in addition to layer growth and deposition, further additional gases may be used to form gas mixtures in gas supplies of a MBGCIB processing system. These gases include germanium-, phosphorus-, and arsenic-containing gases, such as GeH₄, Ge₂H₆, GeH₂Cl₂, GeCl₃H, methylgermane, dimethylgermane, trimethylgermane, tetramethylgermane, ethylgermane, diethylgermane, triethylgermane, tetraethylgermane, GeCl₄, GeF₄, BF₃, AsH₃, AsF₅, PH₃, PF₃, PCl₃, or PF₅, or any combination of two or more thereof.

In any one of the above examples, the first and/or second gas mixture may comprise an optional inert dilution gas. The dilution gas may comprise a noble gas, such as for example, He, Ne, Ar, Kr, Xe, or Rn, which may be different for the first and second gas mixtures.

Further extending the above process, optional third, fourth, etc., gas mixtures may be introduced (not shown), as the process may require, and if the number of available gas supplies and nozzles installed in the MBGCIB system permits.

An apparatus and method for incorporating a PMNS module into a MBGCIB system is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations may have been described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A pre-aligned multi-output nozzle/skimmer (PMNS) module comprising:
a support tube having a substantially closed portion and a substantially open portion coupled to the substantially closed portion, the support tube defining a partially-open process space;
a nozzle assembly structure removably coupled to the substantially closed portion of the support tube;
a skimmer subassembly removably coupled to the substantially open portion of the support tube, the skimmer subassembly including at least one skimmer opening and corresponding skimmer output; and
a dual nozzle assembly coupled to the nozzle assembly structure and having a first nozzle configured to emit a first pre-aligned internal beam of gas clusters towards one of the at least one skimmer opening and a second nozzle configured to emit a second pre-aligned internal beam of gas clusters towards one of the at least one skimmer opening, the skimmer subassembly creating an external multi-beam gas cluster beam (MBGCB) from the first pre-aligned internal beam and the second pre-aligned internal beam, and emitting the MBGCB from the at least one corresponding skimmer output.

2. The PMNS module of claim 1, wherein the dual nozzle assembly is removably coupled to the nozzle assembly structure.

3. The PMNS module of claim 1, wherein the skimmer subassembly comprises at least one inner skimmer element in the partially-open process space extending from the at least one skimmer opening outwardly to an internal wall of the skimmer subassembly, and having a length (l₀) between the at least one skimmer opening and the internal wall that varies from about 20 mm to about 40 mm and an angle (a₀) from the internal wall that varies from about 100 degrees to about 175 degrees and wherein the skimmer subassembly comprises at least one outer shaping element extending from the at least one skimmer opening in the partially-open process space outwardly to a circular opening adjacent an external wall of the skimmer subassembly and having a length (l₁) from the at least one skimmer opening to the circular opening that varies from about 20 mm to about 40 mm and an angle (a₁) extending from a plane of the at least one skimmer opening to a surface of the at least one outer shaping element that varies from about 95 degrees to about 135 degrees.

4. The PMNS module of claim 1, wherein the at least one skimmer opening and corresponding skimmer output includes first and second skimmer openings and corresponding first and second skimmer outputs, wherein the first nozzle is configured to emit the first pre-aligned internal beam of gas clusters towards the first skimmer opening and the second nozzle is configured to emit the second pre-aligned internal beam of gas clusters towards the second skimmer opening.

5. The PMNS module of claim 1, further comprising:
a single nozzle assembly coupled to the nozzle assembly structure and having a third nozzle configured to emit a third pre-aligned internal beam of gas clusters,
wherein the at least one skimmer opening and corresponding skimmer output includes first and second skimmer openings and corresponding first and second skimmer outputs, and
wherein the first and second nozzles are configured to emit the first and second pre-aligned internal beams of gas clusters towards the first skimmer opening and the third nozzle is configured to emit the third pre-aligned internal beam of gas clusters towards the second skimmer opening for inclusion in the created MBGCB.

6. The PMNS module of claim 1, further comprising:
another dual nozzle assembly coupled to the nozzle assembly structure and having a third nozzle configured to emit a third pre-aligned internal beam of gas clusters and a fourth nozzle configured to emit a fourth pre-aligned internal beam of gas clusters,
wherein the at least one skimmer opening and corresponding skimmer output includes first and second skimmer openings and corresponding first and second skimmer outputs, and
wherein the first and second nozzles are configured to emit the first and second pre-aligned internal beams of gas clusters towards the first skimmer opening and the third and fourth nozzles are configured to emit the third and fourth pre-aligned internal beams of gas clusters towards the second skimmer opening for inclusion in the created MBGCB.

7. The PMNS module of claim 1, wherein the at least one skimmer opening has a diameter (ds₀) varying from about 0.5 mm to about 5 mm, and the corresponding skimmer output has a diameter (ds₁) varying from about 1 mm to about 10 mm.

8. The PMNS module of claim 1, wherein the first nozzle has a first nozzle length (lₙ₁), a first nozzle opening angle (aₙ₁), and a first nozzle diameter (dₙ₁) and the second nozzle has a second nozzle length (lₙ₂), a second nozzle opening angle (aₙ₂), and a second nozzle diameter (dₙ₂).

9. The PMNS module of claim 1, wherein a third nozzle is coupled to the nozzle assembly structure and is configured to emit a third pre-aligned internal beam of gas clusters towards one of the at least one skimmer opening for inclusion in the created MBGCB.

10. The PMNS module of claim 9, wherein a fourth nozzle is coupled to the nozzle assembly structure and is configured to emit a fourth pre-aligned internal beam of gas clusters towards one of the at least one skimmer opening for inclusion in the created MBGCB.

11. The PMNS module of claim 1, wherein a beam summation point is established proximate the at least one skimmer opening in the partially-open process space, the beam summation point being established for receiving the first pre-aligned internal beam of gas clusters and the second pre-aligned internal beam of gas clusters.

12. A multi-beam gas cluster ion beam (MBGCIB) processing system comprising:
a source subsystem having a source chamber;
an ionization/acceleration subsystem having an ionization/acceleration chamber, wherein the ionization/acceleration subsystem is coupled to the source subsystem;
a processing subsystem having a processing chamber, wherein the processing subsystem is coupled to the ionization/acceleration subsystem, the processing chamber including a workpiece holder configured to hold a workpiece; and
the pre-aligned multi-output nozzle/skimmer (PMNS) module of claim 1 coupled to an interior wall of the source chamber and configured to provide the MBGCB into the ionization/acceleration chamber.

13. A multi-beam gas cluster ion beam (MBGCIB) processing system comprising:
a source subsystem having a source chamber;
an ionization/acceleration subsystem having an ionization/acceleration chamber, wherein the ionization/acceleration subsystem is coupled to the source subsystem;
a processing subsystem having a processing chamber, wherein the processing subsystem is coupled to the ionization/acceleration subsystem, the processing chamber including a workpiece holder configured to hold a workpiece; and
the pre-aligned multi-output nozzle/skimmer (PMNS) module of claim 4 coupled to an interior wall of the source chamber and configured to provide the MBGCB into the ionization/acceleration chamber.

14. A multi-beam gas cluster ion beam (MBGCIB) processing system comprising:
a source subsystem having a source chamber;
an ionization/acceleration subsystem having an ionization/acceleration chamber, wherein the ionization/acceleration subsystem is coupled to the source subsystem;
a processing subsystem having a processing chamber, wherein the processing subsystem is coupled to the ionization/acceleration subsystem, the processing chamber including a workpiece holder configured to hold a workpiece; and
the pre-aligned multi-output nozzle/skimmer (PMNS) module of claim 5 coupled to an interior wall of the source chamber and configured to provide the MBGCB into the ionization/acceleration chamber.

15. The MBGCIB processing system of claim 14, wherein a beam summation point is established proximate the first skimmer opening in the partially-open process space, the beam summation point being established for receiving the first pre-aligned internal beam of gas clusters and the second pre-aligned internal beam of gas clusters.

16. A multi-beam gas cluster ion beam (MBGCIB) processing system comprising:
a source subsystem having a source chamber;
an ionization/acceleration subsystem having an ionization/acceleration chamber, wherein the ionization/acceleration subsystem is coupled to the source subsystem;
a processing subsystem having a processing chamber, wherein the processing subsystem is coupled to the ionization/acceleration subsystem, the processing chamber including a workpiece holder configured to hold a workpiece; and
the pre-aligned multi-output nozzle/skimmer (PMNS) module of claim 6 coupled to an interior wall of the source chamber and configured to provide the MBGCB into the ionization/acceleration chamber.

17. The MBGCIB processing system of claim 16, wherein a first beam summation point is established proximate the first skimmer opening and a second beam summation point is established proximate the second skimmer opening in the partially-open process space, the first beam summation point being established for receiving the first pre-aligned internal beam of gas clusters and the second pre-aligned internal beam of gas clusters, the second beam summation point being established for receiving the third pre-aligned internal beam of gas clusters and the fourth pre-aligned internal beam of gas clusters.

18. The MBGCIB processing system of claim 12, wherein the dual nozzle assembly is removably coupled to the nozzle assembly structure.

19. The MBGCIB processing system of claim 12, wherein the at least one skimmer opening has a diameter (ds₀) varying from about 0.5 mm to about 5 mm, and the corresponding skimmer output has a diameter (ds₁) varying from about 1 mm to about 10 mm.

20. The MBGCIB processing system of claim 12, wherein a beam summation point is established proximate the at least one skimmer opening in the partially-open process space, the beam summation point being established for receiving the first pre-aligned internal beam of gas clusters and the second pre-aligned internal beam of gas clusters.
